(19) United States
(12) Patent Application Publication
(10) Pub. No.: US 2026/0236951 A1
(43) Pub. Date: Aug. 13, 2026

(54) COMPUTER SYSTEMS AND METHODS FOR PREDICTING AND MITIGATING EMPLOYEE ATTRITION

(71) Applicant: Capital One Financial Corporation, McLean, VA (US)

(72) Inventors: Yuan Xiang, Chicago, IL (US); Prithvi Tanna, Chicago, IL (US); Bowen Wu, Northbrook, IL (US); Johnnie Teng, Chicago, IL (US)

(21) Appl. No.: 19/048,613

(22) Filed: Feb. 7, 2025

(51) Int. Cl. G06Q 30/0202; G06Q 10/0639; G06Q 10/1053

(52) U.S. Cl. CPC G06Q 30/0202; G06Q 10/06398; G06Q 10/1053

(57) ABSTRACT

A software-based pipeline that functions to (i) load data for a given set of employees of an employer, (ii) based on the loaded data, prepare input data for a set of artificial intelligence (AI) models that are each configured to (a) receive a set of input data related to an employee and (b) based on an evaluation of the received input data, generate a prediction of whether the employee is likely to leave the employer within a model-specific timeframe in the future, and (iii) utilize the set of AI models to generate and output, for each respective employee in the given set, a respective set of predictions of whether the respective employee is likely to leave the employer within each of the model-specific timeframes in the future.

### BACKGROUND

Employees are, in a sense, the backbone of most employers. In addition to performing the day-to-day work that generates the products or services that the employer offers, employees may also serve as innovators and brand ambassadors whose contributions can accelerate company growth and increase an employer's value and revenue. For these and other reasons, many employers invest significant time and effort into tasks such as hiring, managing, and retaining their employees.

### OVERVIEW

Disclosed herein is new software technology for preemptively predicting whether and when employees are likely to leave an employer and then using such employee-attrition predictions as a basis for performing other actions that help to reduce the extent and/or impact of future employee attrition.

In one aspect, the disclosed technology may take the form of a method to be carried out by a computing platform that involves (i) loading employee-related data for a given set of employees of an employer, (ii) based on the loaded employee-related data, preparing input data for a set of artificial intelligence (AI) models that are each configured to (a) receive a set of input data related to an employee and (b) based on an evaluation of the received input data, generate a prediction of whether the employee is likely to leave the employer within a model-specific timeframe in the future, (iii) utilizing the set of AI models to generate and output, for each respective employee in the given set, a respective set of predictions of whether the respective employee is likely to leave the employer within each of the model-specific timeframes in the future, (iv) based on the respective sets of predictions that are generated and output by the set of AI models, predicting that a future hiring need is likely to arise with respect to at least one given position within the employer, and (v) carrying out one or more actions for enabling the employer to preemptively address the predicted future hiring need.

The one or more actions may take any of various forms, and in example embodiments, may include at least one of a remunerative action, a training action, a workload-calibration action, a career-progression action, or a feedback-based action.

Further, in some example embodiments, the function of carrying out the one or more actions for enabling the employer to preemptively address the predicted future hiring need may involve one or both of (i) utilizing a generative AI model to generate a job listing for the at least one given position based on the predicted future hiring need and/or (ii) causing an alert to be presented to a user based on the predicted future hiring need.

Further yet, in some example embodiments, the method may involve additional functionality. For instance, as one possibility, the method may additionally involve generating, for each respective prediction of at least a subset of the employee-attrition predictions, a respective set of employee-level feature contribution values based on a respective AI model that was utilized to generate the respective prediction in the set of AI models. As another possibility, the method may additionally involve generating, for each respective employee in at least a subset of the given set of employees, a respective retention strategy based on a respective set of input data related to the respective employee. As yet another possibility, the method may additionally involve (i) selecting, from among the given set of employees, a group of employees who are similar to each other with respect to at least one of a department, a team, a job title, or a job function, and (ii) generating a retention strategy for the group of employees based on respective sets of input data related to respective employees in the group. The method may involve other functionality as well.

In yet another aspect, disclosed herein is a computing platform that includes a communication interface for communicating over at least one data network, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still another aspect, disclosed herein is a non-transitory computer-readable medium provisioned with program instructions that, when executed by at least one processor, cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network environment in which aspects of the disclosed software technology disclosed herein can be implemented.

FIG. 2 depicts block diagram of an example software-based pipeline that carries out functionality disclosed herein.

FIG. 3 shows an example graphical user interface (GUI) visualization that may be presented based on the output data of the example software-based pipeline.

FIG. 4 is a flow chart of example of functionality that may be carried out in accordance with the software technology disclosed herein.

FIG. 5 depicts a simplified block diagram to illustrate some structural components that may be included in an example computing platform that may be configured to perform some or all of the platform functions disclosed herein.

FIG. 6 depicts a simplified block diagram to illustrate some structural components that may be included in an example client device that may be configured to perform some or all of the client-device functions disclosed herein.

### DETAILED DESCRIPTION

As noted above, given the importance of employees to the success of most employers, such employers typically invest significant time and effort into tasks such as hiring, managing, and retaining their employees. And in order to perform these tasks effectively, an employer generally has to collect and analyze various types of data about employees for management and retention purposes as well as prospective employees for hiring purposes.

For instance, in order to manage and retain employees effectively, an employer may collect and maintain any of various different categories of data about its employees, examples of which may include (i) personal data such as names, social security numbers, dates of birth, home addresses, email addresses, phone numbers, and emergency contacts, (ii) employment data such as job titles, departments, start dates, end dates (when applicable), work schedules, employment statuses (e.g., full time, part time, on leave, etc.) and employment contracts, (iii) payroll data such as salaries (e.g., for full-time employees), hourly rates (e.g., for part-time employees), commissions, incentives, bonuses, deductions (e.g., for taxes, insurance, etc.), account numbers (e.g., for direct deposits), and pay stubs, (iv) benefits data such as insurance data (e.g., provider and plan information for health, dental, vision, life, disability, and other types of insurance), paid time-off balances, sick leave, vacation time balances, and benefit eligibility data, (v) work-time data such as time clock entries, requests for time off, manager approvals of requests for time off, overtime eligibility, and amounts of overtime worked, (vi) compliance data such as employment eligibility documentation (e.g., I-9 forms for the United States), age verification documentation (e.g., to ensure compliance with child labor laws), and data identifying legally protected classes to which employees belong (e.g., classes protected under laws such as the Equal Employment Opportunity Act of 1972 and the Uniformed Services Employment and Reemployment Rights Act (USERRA) in the United States), among other possible examples of data categories related to employees that may be collected and maintained by an employer.

In addition, in order to hire new employees effectively, an employer may collect and maintain any of various different categories of data about prospective employees (e.g., job applicants who have submitted résumés, cover letters, and other application materials in hopes of being hired by the employer), examples of which may include (i) personal information such as the types of personal information mentioned above), (ii) work history data such as previous employers, previous job titles, former dates of employment with previous employers, and previous job responsibilities, (iii) education data such as degrees held, training completed, professional licenses held, and certifications obtained, (iv) compliance data such as the types of compliance data mentioned above, and/or (v) assessment data such as answers to screening questions, notes from interviewers, and scores from assessment tests, among other possible examples of data categories related to prospective employees that may be collected and maintained by an employer.

However, as an employer grows, so too does the volume of data that it has to collect and maintain related to and prospective employees, and at a certain point, it becomes practically impossible for an employer to collect and maintain data related to its and prospective employees without the assistance of technology. For instance, there are many employers that have hundreds or even thousands of employees (e.g., such as the more than 100,000 employers worldwide that have more than the more than one hundred employees and the more than 24,000 employers worldwide that have more than one thousand employees), and as a practical matter, it is not possible for these employers to collect and manage data related to their and/or prospective employee without the assistance of technology.

An employer's task of collecting and maintaining employee-related data is made even more difficult by the fact that at least some of the employee-related data is sensitive in nature and needs to be maintained in a secure way. Indeed, laws in many jurisdictions impose regulations about how sensitive data (e.g., social security numbers and other personal data) is to be used, handled, and stored. For instance, the General Data Protection Regulation (GDPR), which applies in European Union (EU) member states, mandates that appropriate measures be taken to secure personal data—and such appropriate measures may involve encrypting personal data (e.g., in accordance with Federal Information Processing Standards (FIPS) such as the Advanced Encryption Standard (AES)) via encryption algorithms. However, it is typically not possible for employers to comply with these regulations without the assistance of technology.

In view of the foregoing, technology has been developed to help employers collect, securely maintain, and effectively utilize data related to their and/or prospective employees. Generally speaking, this technology takes the form of specialized software applications (e.g., software-as-a-service (SaaS) applications) that provide functionality for collecting, securely maintaining, and utilizing data related to and/or prospective employees in order to facilitate tasks related to managing, retaining, and/or hiring employees.

One example of the existing technology that provides functionality related to employee-related data is a category of software applications that are commonly referred to as Human Capital Management (HCM) applications or Human Resources Management (HRM) applications, which provide various functionality for collecting, maintaining, and utilizing data related to an employer's employees in order to facilitate tasks related to management and retention of such employees. For example, existing HCM and/or HRM applications may integrate various technological tools to streamline and automate HR functions.

For instance, HCM and/or HRM applications may use cloud-based or on-premises databases to store vast amounts of employee-related data securely. Advanced encryption techniques may be used to ensure that sensitive data remains protected. Cloud storage may be used to facilitate scalability so that employers can easily expand their storage capacity as they grow without having to expand their physical computing infrastructure.

Further, HCM and/or HRM applications may implement efficient data-retrieval platforms that utilize search algorithms and user-friendly dashboards to facilitate rapid retrieval of specific data. For example, when HR managers want to view an employee's records, they can use software tools such as a search bars and filters to access the relevant data without manually searching through hard copies of documents. Artificial intelligence can also be utilized to auto-complete queries and recommend relevant records based on user queries, further speeding up data retrieval.

Further yet, HCM and/or HRM applications may automate the creation of employee records, thereby reducing the possibility of human error. For example, when an employee is hired, HCM and/or HRM applications may generate a corresponding employee profile by pulling data from electronic forms (or paper documents via optical character recognition), predictively populate fields for different types of information, and ensure data integrity by applying data-verification functions (running a spell check, utilizing an address-validation application programming interface, etc.). Integration across different software modules (e.g., payroll modules, attendance modules, etc.) may ensure that the records remains accurate, up-to-date, and consistent from one module to another.

Further yet, HCM and/or HRM applications may include software modules for tracking time and/or attendance. Such modules may leverage technologies like biometric scanners, Radio Frequency Identification (RFID) badges, and/or location-enabled mobile apps (e.g., which use Global Positioning System (GPS) data and/or Bluetooth Low Energy (BLE) beacon data) to track employee working hours. Cloud-based systems may facilitate real-time monitoring such that employees can log in remotely and managers can oversee attendance trends from any location.

Further yet, HCM and/or HRM applications may uses data analytics tools to generate reports on various metrics, such as timeliness, productivity, and the like. Such reports may be customized and exported into formats like Excel® or Portable Document Format (PDF). Some HCM and/or HRM applications offer built-in report templates, visual dashboards, and data visualization features (e.g., charts and graphs) that simplify the task of interpreting large datasets.

Some representative examples of existing HCM and/or HRM applications include Workday® and Deel®, both of which are SaaS applications that provide HCM and/or HRM functionality. In addition, productivity-monitoring software (e.g., ActivTrak®, Teramind®, Hubstaff®, Time Doctor®, etc.) may also be used (e.g., in combination with HCM and/or HRM applications) to provide functionality for tracking employee-related data pertinent to productivity.

As a practical matter, given the cumulative volume of the data that most employers collect and maintain about employees, and given the consequences that may result from a failure to maintain that data properly, such employers have little choice but to use the types of software applications mentioned above. However, the existing HCM and/or HRM software applications are plagued by a number of drawbacks.

For example, most of the HCM and/or HRM applications that are currently available on the market lack functionality for evaluating or reducing the extent and impact of employee attrition, which can lead to a host of negative consequences for large and small employers alike. For instance, when a given employee leaves a given position, there is often an interim time period between the given employee's last day of work and the first day of work for a person hired to replace the given employee. During that interim time period, work that would ordinarily be done by a person in the given position might not be done at all, resulting in a loss of productivity. In some cases, it might be possible for other employees to do that work, but that may lead to disgruntled employees, loss of productivity in other areas, cost increases (e.g., if those other employees have to be paid overtime), and perhaps even further employee attrition (e.g., if the other employees eventually decide to leave as well due to an increased workload).

Additionally, once a given employee decides to leave an employer, this typically kicks off a sequence of additional tasks that for the employer to perform in order to fill the given employee's position. For instance, supervisors for the given position and HR employees will generally have to dedicate time to writing, editing, and posting a job listing for the given position. Further, when job applicants respond to the job listing, the supervisors and HR employees will generally have to dedicate additional time to evaluate the job applicants by inspecting résumés and conducting interviews. Further yet, after the supervisors agree to make a job offer to a job applicant, the supervisors and the HR employees may have to spend additional time creating the job offer and perhaps also negotiating and considering any counteroffers. Still further, if the job applicant declines the job offer altogether, the supervisors and the HR employees may have to spend yet more time selecting a different job applicant, creating another job offer, and possibly negotiating. This negatively impacts the employer in a few different ways. First, the supervisors and the HR employees involved in this process may be pulled away from performing other tasks to help the employer, which may result in a loss of productivity. Second, this process may go on for weeks or even months before the given employee's position is filled, which compounds the negative consequences discussed above resulting from the given employee's departure.

Additionally yet, even after a new person hired to replace the departing employee begins working, there will typically be an initiatory time period in which the hired person is less productive than the given employee while the hired person is being onboarded and trained. Again, during that initiatory time period, work that ordinarily would be done by the person in the given position might not be done at all or might be done by other employees, which may still give rise to the types of negative consequences discussed above.

For these and other reasons, employers generally have a desire to avoid employee attrition whenever possible, and in scenarios where employee attrition is unavoidable, employers generally have a desire to identify the possibility of that employee attrition as early as possible so that the employer can minimize the amount of time that a position remains unfilled and thereby mitigate the negative consequence discussed above. However, it is typically not possible for humans to assess the extent and impact of potential employee attrition accurately or reliably given the many factors that go into that assessment—particularly for employers with a larger number of employees—and as noted above, most of the HCM and/or HRM applications that are currently available on the market lack functionality for evaluating or reducing the extent and impact of employee attrition. For instance, most of the HCM and/or HRM applications that are currently available on the market lack functionality for predicting the extent of future employee attrition in an accurate or reliable way—let alone functionality for using predictions of future employee attrition as a basis for taking preemptive actions in order to reduce the extent and/or impact of such future employee attrition, such as preemptively generating employee retention strategies and/or preemptively initiating a workflow for filling a position that is expected to open up in the future due to employee attrition.

The drawbacks of the existing technologies listed above are merely illustrative, as there are other drawbacks and technical problems with existing HCM and/or HRM software applications.

To address these and other problems with existing technology for collecting, maintaining, utilizing, and analyzing data related to employees, such as existing HCM and/or HRM applications, disclosed herein is new software technology for leveraging the employee-related data of an employer to assist with the tasks of managing, retaining, and/or hiring employees.

For instance, one aspect of the disclosed software technology is directed to an example software-based pipeline that carries out functionality for preemptively predicting whether and when employees are likely to leave an employer and then using such employee-attrition predictions as a basis for performing other actions that help to reduce the extent and/or impact of future employee attrition, such as (i) identifying factors that are likely to be contributing to employee attrition, (ii) generating retention strategies for employees that are predicted to leave, (iii) preemptively predicting where a hiring need will arise within the employer, and (iv) presenting users with output data related to employee attrition, retention, and/or hiring need, among other possible functionality.

The disclosed technology may take other forms and include various other functionality as well.

In this way, the disclosed software technology includes specific data-driven capabilities that are predictive and/or generative rather than solely reactive, thereby providing a number of advantages over existing HCM and/or HRM technologies.

For instance, the disclosed software technology implements an employee-attrition prediction component that can predict whether a given employee will leave an employer in the foreseeable future. In some implementations, the employee-attrition prediction component may provide detailed time granularity for its predictions by specifying or more applicable timeframes in which an employee is considered likely to leave. The employee-attrition prediction component predicts attrition with both accuracy and sufficient time granularity to reduce the extent and impact of employee attrition (e.g., by providing sufficient lead time for the employer to act upon recommendations the disclosed software technology provides).

Further, in at least some implementations, the software technology may include an explainability component that generates explanations that can elucidate why certain employees—both as individuals and as groups—have been predicted to leave. In particular, the explainability component determines respective contribution values that reflect the extent to which a different factor influenced the predictions made by the employee-attrition prediction component, thereby providing data that facilitate discovery of root causes of attrition for the employer specifically.

Further yet, in some implementations, the disclosed software technology provides a retention-recommendation component that can preemptively generate respective retention strategies for retaining specific employees (and groups of employees) based on, for example, the explanations generated by the explainability component and/or employee-related data. The retention-recommendation component may generate these retention strategies with sufficient lead time for those strategies to be carried out before employees decides to leave. The retention strategies may include specific actions that can be taken to reduce the probability that the specific employees will leave the employer.

Further still, in some implementations, the disclosed software technology may provide a hiring-need component that predicts where hiring needs will arise within an employer based on the predictions made by the employee-attrition prediction component. In at least some implementations, the hiring-need component may specify timeframes in which employees are predicted to leave the employer. Further still, in some implementations, the hiring-need component may perform any of various actions for addressing the predicted hiring needs (e.g., by outputting alerts, initiating workflows for posting job listings for positions where hiring needs are predicted to arise, automatically generating job listings for positions, etc.). This allows the workload involved in interviewing, hiring, onboarding, and training to be initiated before the employees leave, thereby allowing the workload of bringing on new employees to be distributed over an earlier time period. As a result, a recent hire can be ready to fill the shoes of a departing employee sooner—perhaps even before the day that the employee leaves—so that there will little or no interim time in which the employer will lack sufficient personnel to do available work.

Still further, in some implementations, the software technology includes an output interface for presenting the output of the other components of the software technology to a user and for allowing the user to perform one or more actions (e.g., actions that are included in retention strategies output by the retention-recommendation component, posting job listings generated by the hiring-need component, etc.). The disclosed software technology also provides other advantages over the existing technology which are apparent from the detailed discussion of the software technology that follows.

In practice, the disclosed software technology may be incorporated into a software application that is hosted on a back-end computing platform and is accessible by client devices over a communication path that typically includes the Internet (among other data networks that may be included). In this respect, the disclosed software technology may comprise server-side software installed on the back-end computing platform as well as client-side software that runs on the client devices and interacts with the server-side software, which could take the form of a client application running in a web browser (sometimes referred to as a “web application”), a native desktop application, or a mobile application, among other possibilities. However, the software technology could take other forms and/or be implemented in other manners as well.

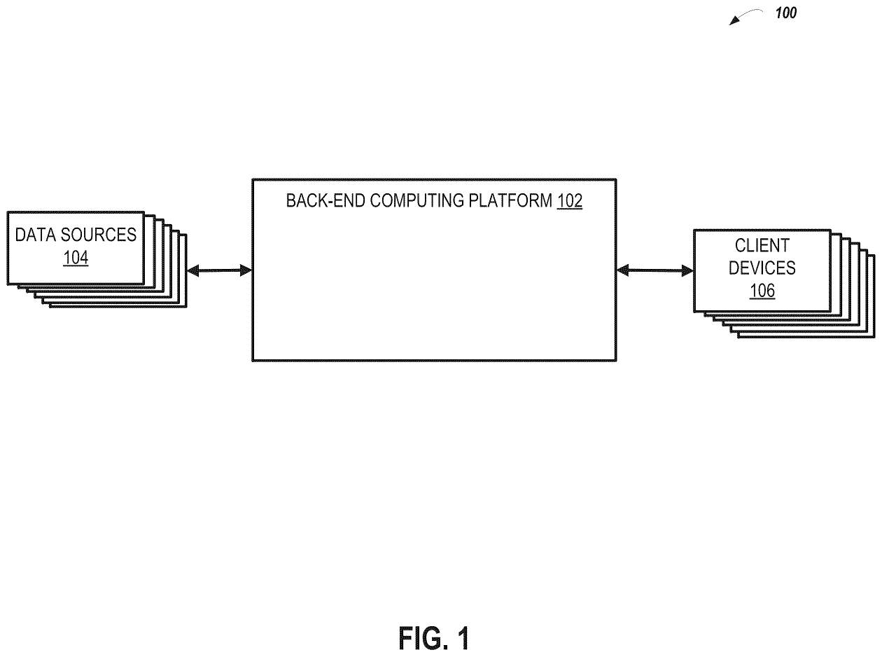

Turning now to the figures, FIG. 1 depicts one illustrative example of a computing environment 100 in which the disclosed software technology may be implemented. As shown, the example computing environment 100 may include a back-end computing platform 102 operated by on behalf of an entity that is involved in the task of managing, retaining, and/or hiring employees (which may at times be referred to herein as an “employer”), a plurality of data sources 104, and a plurality of client devices 106, among other possibilities.

The back-end computing platform 102 may comprise any one or more computer systems (e.g., one or more servers) that have been installed with software for carrying out the back-end functionality disclosed herein. In practice, the one or more computer systems of the back-end computing platform 102 may collectively comprise some set of physical computing resources (e.g., one or more processors, data storage system, communication interfaces, etc.), which may take any of various forms. As one possibility, the back-end computing platform 102 may comprise cloud computing resources supplied by a third-party provider of “on demand” cloud computing resources, such as Amazon Web Services (AWS), Amazon Lambda, Google Cloud, Microsoft Azure, or the like. As another possibility, the back-end computing platform 102 may comprise “on-premises” computing resources of the given provider (e.g., servers owned by the given provider). As yet another possibility, the back-end computing platform 102 may comprise a combination of cloud computing resources and on-premises computing resources. Other implementations of the back-end computing platform 102 are possible as well.

Further, in practice, the software for carrying out the back-end functionality disclosed herein may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the software for carrying out the back-end functionality disclosed herein may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities. Such a data storage layer of the back-end computing platform 102 may contain any of various types of data, including but not limited to any of the various types of data involved in carrying out the back-end functionality disclosed here (e.g., employee-related data for past, current, and/or prospective employees).

As shown, the back-end computing platform 102 may be communicatively coupled to a plurality of data sources 104 over respective communication paths. In general, each of these data sources 104 may comprise a computing system that is configured to provide the back-end computing platform 102 with data related to the back-end functionality disclosed herein, such as employee-related data for past, current, and/or prospective employees, among other possible types of data that may be provided by the data sources 104. As some representative examples, each such data source 104 could take the form of a computing platform that is running a software application for collecting and maintaining employee-related data (e.g., HCM and/or HRM software), among various other possibilities.

As further shown, the back-end computing platform 102 may be communicatively coupled to a plurality of client devices 106 over respective communication paths. In general, each of these client devices 106 may comprise any computing device that enables a user to access and interact with the back-end computer platform 102 in order to carry out tasks related to the disclosed back-end functionality, such as configuration of the back-end functionality and/or evaluation of output provided by back-end computing platform 102. In this respect, each client device 106 may include hardware components such as one or more processors, computer-readable mediums, communication interfaces, and input/output (I/O) components (or interfaces for connecting thereto), among other possible hardware components, as well as software that enables a user to access and interact with the back-end computing platform 102 in order to carry out tasks related to the disclosed back-end functionality (e.g., operating system software, web browser software, a mobile application, etc.). As representative examples, each of example client devices 106 may take the form of a desktop computer, a laptop, a netbook, a tablet, a smartphone, or a personal digital assistant (PDA), among other possibilities.

In practice, the respective communication path between the back-end computing platform 102 and each data source 104 or client device 106 may generally comprise one or more data networks and/or data links, which may take any of various forms. For instance, the respective communication path between the back-end computing platform 102 and a given data source 104 or client device 106 may include any one or more of a Personal Area Network (PAN), a Local Area Network (LAN), a Wide Area Networks (WAN) such as the Internet or a cellular network, a cloud network, and/or a point-to-point data link, among other possibilities, where each such data network and/or link may be wireless, wired, or some combination thereof, and may carry data according to any of various different communication protocols. Additionally, the communication between the back-end computing platform 102 and a given data source 104 or client device 106 could be carried out via an Application Programming Interface (API), among other possibilities. Additionally, although not shown, the respective communication path between the back-end computing platform 102 and a given data source 104 or client device 106 could also include one or more intermediate systems, examples of which may include a data aggregation system or a host server, among other possibilities. Many other configurations are also possible.

It should be understood that the computing environment 100 is one example of a computing environment in which the disclosed software technology may be implemented, and that numerous other examples of computing environments are possible as well. For instance, in some implementations, the back-end computing platform 102 may additionally have a communication path with a third-party computing platform that is provided with access to data generated by the back-end computing platform 102 in accordance with the disclosed back-end functionality via an API or the like.

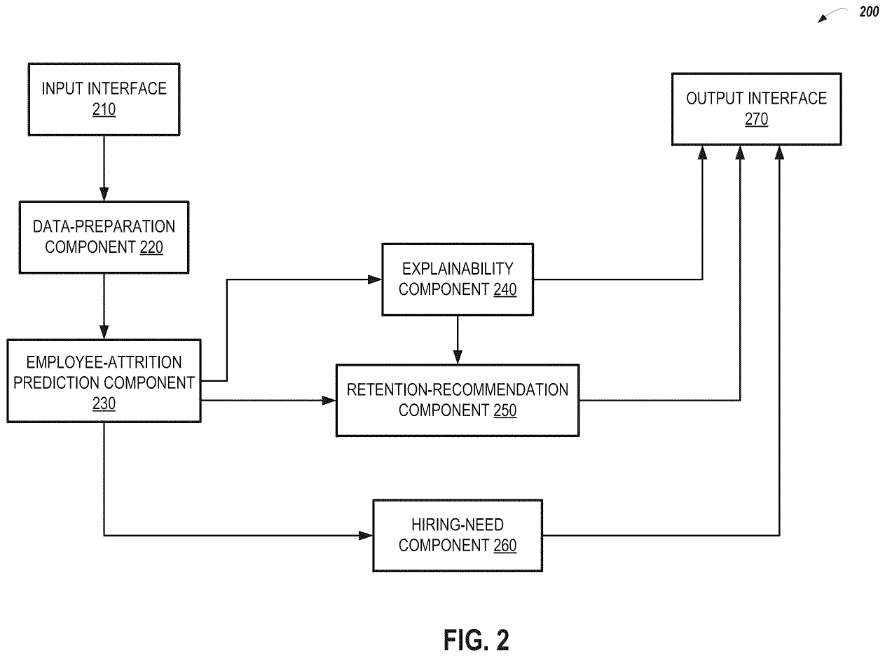

Turning now to FIG. 2, a block diagram of an example software-based pipeline 200 that carries out functionality for preemptively predicting whether and when an employer's employees are likely to leave and then using such employee-attrition predictions as a basis for performing other functions that help to reduce the extent and/or impact of future employee attrition is shown. In practice, the example software-based pipeline 200 may be encoded in the form of program instructions that are executable by one or more processors of a computing platform. For purposes of illustration, the example software-based pipeline 200 is described as being installed on and executed by the back-end computing platform 102 of FIG. 1, but it should be understood that the example software-based pipeline 200 may be installed on and executed by any one or more computing platforms that are capable of performing the example operations of the example software-based pipeline 200. Further, it should be understood that the example software-based pipeline 200 is merely described in this manner for the sake of clarity and explanation and that the example operations may be implemented in various other manners, including the possibility that operations may be added, removed, rearranged into different orders, combined into fewer blocks, and/or separated into additional blocks depending upon the particular embodiment.

As shown, the example software-based pipeline 200 may comprise an input interface 210, a data-preparation component 220, an employee-attrition prediction component 230, an explainability component 240, a retention-recommendation component 250, a hiring-need component 260, and an output interface 270, each of which will be described in further detail below. Other implementations of software-based pipelines for carrying out the disclosed functionality are also possible.

As shown in FIG. 2, the example software-based pipeline 200 may begin with the input interface 210, which functions to (i) load employee-related data for a given set of employees (which could be all of the employees employed by an employer or a subset thereof) that may be utilized as a basis for predicting whether and when those employees are likely to leave and then (ii) pass the loaded employee-related data to the data-preparation component 220. The employee-related data for the given set of employees that may be loaded by the input interface 210 may take any of various forms.

For instance, as one possibility, the loaded employee-related data for the given set of employees may include job description data. Job description data may include job titles for the jobs held by employees, baseline qualifications for those job titles (e.g., be able to lift thirty pounds, hold at least a bachelor of science degree, etc.), departments in which the employees that have those job titles work (e.g., engineering, accounting, legal, etc.), hierarchical authority information for each department (e.g., a chain of command that specifies the immediate supervisors of employees, the supervisors of the immediate supervisors, etc. up to the Chief Executive Officer (CEO) of the employer), longevity data (e.g., how long employees have worked in current and previous positions with the employer) and/or other types of data pertaining to job titles held by employees.

As another possibility, the loaded employee-related data for the given set of employees may include remuneration data. Remuneration data may include compensation data (e.g., salaries, hourly rates, bonuses, commission percentages, pay grades, full or part-time status, pay stubs, dates and amounts of raises, etc.), benefits data (e.g., medical, dental, vision, life, and/or disability insurance plans; paid time off, pensions, stock options, 401k matching percentages, child care benefits, etc.). perk data (e.g., discounts on company and/or third-party products and/or services; company vehicles, company phones, company credit cards, hybrid or work-from-home options, etc.), and/or other data pertaining to how the employer remunerates employees for labor.

As yet another possibility, the loaded employee-related data for the given set of employees may include personal data. Personal data may include data such as contact information (e.g., home addresses, office addresses, phone numbers, email addresses, etc.), educational data (e.g., degrees held and dates obtained; training completed and dates of completion; professional licenses and/or certifications held and dates obtained), language fluencies, and/or other types of data. Note that, in some implementations, there may be particular types of personal data that may be redacted from the employee-related data that the input interface 210 collects. For instance, certain types of personal data that are specify whether employees are members of certain protected classes (e.g., race, ethnicity, nationality, immigration status, gender, marital status, etc.) may be redacted to ensure that one or more data science models (e.g., machine-learning models and/or AI models) that are included in components of the example software-based pipeline 200 (e.g., as will be described with respect to the employee-attrition prediction component 230 and/or the retention-recommendation component 250 further below) do not unwittingly introduce bias against such protected classes of people.

As yet another possibility, the loaded employee-related data for the given set of employees may include performance data. Performance data may include data such as performance reviews, sales metrics, overtime hours worked, productivity data (e.g., data collected by productivity-monitoring software, such as how long employees spend on different tasks, how often employees switch between tasks, how many tasks employees complete, which applications and/or websites employees use, such as the amount of time employees spend using those applications and/or websites, the amount of time employees spend on phone calls, employee usage statistics for I/O components such as keyboards and microphones, the number of emails employees send, the number of instant messages employees send, etc.), and/or other data pertinent to any metrics that the employer may use to measure employee performance.

As yet another possibility, the loaded employee-related data for the given set of employees may include market data. Market data may include industry-specific statistical data for job titles (e.g., such as the job titles included in the job description data), such as median salaries for specific job titles, median durations of time of employment for employees having specific job titles, and other types of data pertaining to the labor market in general.

The input interface 210 may load other types of employee-related data for the given set of employees as well.

Further, the function of loading the employee-related data for the given set of employees may take any of various forms.

For instance, as one possibility, the function of loading the employee-related data for the given set of employees may involve retrieving at least a portion of the employee-related data from a data storage layer of the back-end computing platform 102, which may contain employee-related data that was previously received by the back-end computing platform 102 from another data source 104 and/or was previously generated by the back-end computing platform 102.

As another possibility, the function of loading the employee-related data for the given set of employees may involve obtaining at least a portion of the employee-related data from one or more data sources 104, such as by causing the back-end computing platform 102 to send a request for employee-related data to a given data source 104 via a network-based communication path (e.g., in the form of an HTTP request or the like) and then receive the employee-related data back from the given data source 104 via the network-based communication path (e.g., in the form of an HTTP response or the like). In this respect, as noted above, the one or more data sources 104 may take any of various forms, one example of which may be a separate computing platform that is running a software application for collecting and maintaining employee-related data (e.g., HCM and/or HRM software).

As yet another possibility, the function of loading the employee-related data for the given set of employees may involve retrieving a first portion of the employee-related data from a data storage layer of the back-end computing platform 102 and obtaining a second portion of the employee-related data from one or more data sources 104.

The function of loading the employee-related data for the given set of employees may take other forms as well.

As discussed above, the input interface 210 may be configured to pass the loaded employee-related data for the given set of employees to the data-preparation component 220 of the example software-based pipeline 200, which may function to (i) prepare the loaded employee-related data for input into the employee-attrition prediction component 230 and (ii) pass the employee-related data to the employee-attrition prediction component 230. The form of the employee-related data that is to be provided as input to the employee-attrition prediction component 230—and the functionality for preparing such employee-related data for input to the employee-attrition prediction component 230—may take any of forms.

For instance, in at least some implementations, the employee-attrition prediction component 230 may be configured to receive input data in the form of a set of data records that each represent a respective employee and contain respective values for a given set of feature variables—which may collectively be referred to as “feature data”—and the data-preparation component 220 may be configured to transform the loaded employee-related data into this feature data. Such feature variables may take any of various forms.

For instance, as one possibility, a feature variable may be remuneration-based. For example, a feature variable may comprise an indication of an annual salary. As another example, a feature variable may comprise an indication of a pay grade. As yet another example, a feature variable may comprise an indication of paid time off. As another example, a feature variable may comprise an indication of an amount of time since a last raise.

As another possibility, a feature-variable may be career-based. For example, a feature variable may comprise an indication of a job title. As another example, a feature variable may comprise an indication of line of business (LOB) and/or department in which an employee works. As another example, a feature variable may comprise an indication of an amount of time since a last promotion. As yet another example, a feature variable may comprise an indication of whether an employee is a full-time employee or a part-time employee.

As yet another possibility, a feature variable may be location-based. For example, a feature variable may comprise an indication of a geographical distance between a home address and an office address (e.g., a commuting distance). As another example, a feature variable may comprise an indication of a work location.

As yet another possibility, a feature variable may be time-based. For example, a feature variable may comprise an indication of total unplanned hours. In this context, total unplanned hours may refer to an amount of time when an employee's productivity was affected by an unforeseen disruption (e.g., such as equipment failure, a power outage, etc.). As another example, a feature variable may comprise an indication of total unpaid unplanned hours (e.g., unplanned hours for which an employee was not paid). As yet another example, a feature variable may comprise an indication of total unplanned lag hours (e.g., hours of unplanned delay between the end of a first task and the start of a second task that depended on the first task). As yet another example, a feature variable may comprise an indication of total productive time (e.g., time spent on activities that are considered productive, such as work-related tasks and/or meetings). As yet another example, a feature variable may comprise an indication of tenure (e.g., how long an employee has worked for the employer). As yet another example, a feature variable may comprise an indication of occupancy (e.g., a ratio of productive time to unproductive time, such as call time to after-call time at a call center). As yet another example, a feature variable may comprise an indication of one or more shifts an employee works (e.g., a day shift, an evening shift, a night shift, a weekend shift, an overnight shift, an on-call shift, etc.).

As yet another possibility, a feature variable may be related to customer satisfaction.

As still a further possibility, the feature variables may include other engineered featured variables that are based on one or more of the above examples of feature variables.

The feature variables may also take other forms.

Further, in practice, the given set of feature variables to be input into the employee-attrition prediction component 230 could be defined by a schema. In this respect, the schema may specify the given set of feature variables and perhaps also other related information, such as a respective unit for each feature variable (e.g., dollars, miles, etc.), a respective format for each feature variable (e.g., a numeric format such as integer, decimal, or fraction; a categorical format; and/or an ordinal format), and/or a respective possible range of values for each feature variable, among other possibilities.

Further yet, the function of transforming the loaded employee-related data into the feature data may take various forms. For example, to create a data record that represents a given employee, the data-preparation component 220 may begin by identifying, from the loaded employee-related data, a given set of data associated with the given employee. Next, the data-preparation component 220 may determine feature values for the given employee that map to the given set of feature variables based on the given set of data associated with the given employee. The data-preparation component 220 may then store the feature values for the given employee together as a given data record that represents the given employee.

When carrying out the foregoing functionality, the manner in which the data-preparation component 220 determines features values for the given employee based on the given set of data associated with the given employee may take any of various forms.

For example, as one possibility, the data-preparation component 220 may detect a datum in the given set of data that includes information matching a particular feature variable. In this example, the data-preparation component 220 may detect whether the datum is in a format that a schema specifies for the particular feature variable. If the datum is in the format, the data-preparation component 220 may store the datum as the feature value for the particular feature variable. On the other hand, if the datum is not in the format that the schema specifies for the particular feature variable, the data-preparation component 220 may perform one or more transformation operations to convert the datum into the format (e.g., by projecting the datum into a normalized range for the particular feature variable, rounding and/or truncating decimal values found in the datum, converting the datum from one unit type to another unit type specified by the schema for the particular feature variable, converting the datum from one encoding format to another encoding format, etc.). The data-preparation component 220 may then store the transformed datum as the feature value for the particular feature variable.

As another possibility, the data-preparation component 220 may identify one or more operands in the given set of data that may be used to compute a feature value for a particular feature variable. As an illustrative example, consider a scenario in which the particular feature variable is defined as an average number of sales the given employee closed per time period of a given type (e.g., quarter, month, pay period, week, etc.) worked in the past year. In this example, the data-preparation component 220 may compute a sum of the sales the given employee closed in the past year and may further compute a sum of the time periods of the given type in which the given employee worked in the past year. Next, the data-preparation component 220 may compute a quotient by dividing the sum of the sales (which serves as a dividend) by the sum of the time periods of the given type (which serves as the divisor). The data-preparation component 220 may then store the quotient as the feature value for the particular feature variable. In other examples, the number of computations and the types of computations that the data-preparation component 220 performs to determine the feature value may vary in accordance with the type of feature variable.

As yet another possibility, the data-preparation component 220 may utilize data found in the given set of data to formulate a request to retrieve additional data for determining the feature value for a particular feature variable (e.g., from one of the data sources 104). As an illustrative example, consider a scenario in which the particular feature variable is defined as a commuting distance between the given employee's home address and the address of an office where the given employee works. In this example, the data-preparation component 220 may cause (e.g., instruct) the back-end computing platform 102 to send a request to a data source 104 that stores mapping data (e.g., Google® Maps) via a network-based communication path. The request may indicate the home address and the office address and request that a distance between the home address and the office address be returned in response to the request. After a response from such a data source 104 is received by the back-end computing platform 102, it may be loaded by the software-based pipeline 200 via the input interface 210 and the data-preparation component 220 may then use a distance included in the response as the feature value for the particular feature variable. In other examples, the data-preparation component 220 may cause (e.g., instruct) the back-end computing platform 102 to send different types of requests for different types of data to different types of data sources in accordance with the type of feature variable.

The manner in which the data-preparation component 220 determines features values for the given employee based on the given set of data associated with the given employee may also take other forms.

The form of the employee-related data that is to be provided as input to the employee-attrition prediction component 230—and the functionality for preparing the loaded employee-related data for input into the employee-attrition prediction component 230—may take various other forms as well.

After transforming the loaded employee-related data into feature data, the data-preparation component 220 may pass the feature data to the employee-attrition prediction component 230, which may generally function to (i) predict whether and/or when the given set of employees are likely to leave the employer and then (ii) pass the employee-attrition predictions to other components of the pipeline that are configured to use the employee-attrition predictions as a basis for performing other functions that help to reduce the extent and/or impact of future employee attrition. In this respect, the employee-attrition predictions that generated and output by the employee-attrition prediction component 230—and the functionality carried out by the employee-attrition prediction component 230 to generate such predictions—may take any of various forms.

For instance, in a first implementation, the employee-attrition predictions that are generated and output by the employee-attrition prediction component 230 may take the form of predictions of whether employees are likely to leave the employer within a given timeframe in the foreseeable future, such as within some number of days or months in the future (e.g., within the next month, the next two months, etc.) relative to the time when the prediction is being made (e.g., the current time). In this first implementation, the form of each such prediction may comprise a binary indicator of whether or not a respective employee is likely to leave within the given timeframe in the foreseeable future (e.g., a 0/1 value or a no/yes value) or a numeric value that qualifies a likelihood that the respective employee is likely to leave within the given timeframe in the foreseeable future (e.g., a value from 0 to 1 or 0 to 100), among other possibilities. To illustrate with a simplified example, if the given set of employees includes three employees, then the employee-attrition prediction component 230 may function to generate and output a first prediction of whether a first employee is likely to leave the employer within the given timeframe in the foreseeable future, a second prediction of whether a second employee is likely to leave the employer within the given timeframe in the foreseeable future, and a third prediction of whether a third employee is likely to leave the employer within the given timeframe in the foreseeable future.

In this first implementation, the employee-attrition prediction component 230 may generate and output such employee-attribution predictions using a data science model, which may take any of various forms. For instance, as one possibility, the employee-attrition prediction component 230 may utilize an artificial intelligence (AI) model that is configured to (i) receive feature data for an employee that comprises values for a given set of feature variables that define the AI model's input, and (ii) based on an evaluation of the feature data, generate and output a prediction of whether the employee is likely to leave the employer within a given timeframe in the future. Such an AI model may take any of various forms.

To begin, the given set of feature variables that define such an AI model's input may include any of various types of feature variables that may be predictive of whether the respective employee is likely to leave the employer within the given timeframe in the future), including, but not limited to, any of various types of feature variables described above.

Further, in line with the discussion above, the prediction that is generated and output by such an AI model may take the form of a binary indicator of whether or not an employee is likely to leave within the given timeframe in the future (e.g., a 0/1 value or a no/yes value) or a numeric value that qualifies a likelihood that the employee is likely to leave within the given timeframe in the future (e.g., a value from 0 to 1 or 0 to 100), among other possibilities.

Further yet, such an AI model may take any of various forms, including but not limited to any of various forms of AI models that are created utilizing a machine-learning process that involves one or more machine learning techniques, examples of which may include a regression model, a decision-tree-based model (e.g., a gradient boosting model, random forest model, etc.), a support vector machines (SVM)-based model, a Bayesian model, a k-Nearest Neighbor (kNN) model, a Gaussian process model, a deep learning model (e.g., a feedforward, recurrent, or convolution neural-network model, a generative adversarial network (GAN) model, an autoencoder-based model, a transformer-based model, etc.), a clustering model, an association-rule model, a dimensionality-reduction model, and/or a reinforcement-learning model, among other possible examples of AI models that can be created using machine learning techniques.

In practice, the process of creating such an AI model using a machine-learning process may involve (i) obtaining a training dataset for training the AI model, which may comprise data records for employees that include values for the given set of feature variables (and perhaps other candidate feature variables) at certain reference times in the past and perhaps also ground-truth values indicating whether or not the employees left the employer within some timeframe after the reference times that corresponds to the given timeframe in the future (e.g., one or more months after the reference times), and then (ii) applying a machine-learning process (e.g., a process involving supervised, semi-supervised, and/or unsupervised machine learning techniques) to the training data one or more times in order to train one or more instances of the AI model (sometimes referred to as a “model objects”). Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (or sometimes referred to as a “test dataset”) that has a similar form to the generated training dataset and then selecting the instance of the AI model having the best performance. The process of creating an AI model may take various other forms as well.

In this first implementation, the functionality for generating and outputting employee-attribution predictions may take other forms as well.

In a second implementation, the employee-attrition predictions that are generated and output by the employee-attrition prediction component 230 may take the form of predictions of whether employees are likely to leave the employer within each of multiple different timeframes in the foreseeable future. For instance, for each respective employee in the given set, the employee-attrition prediction component 230 may generate and output a first prediction of whether the respective employee is likely to leave the employer within a first timeframe in the future, a second prediction of whether the respective employee is likely to leave the employer within a second timeframe in the future, and so on for any other timeframes for which the employee-attrition prediction component 230 is to generate and output predictions. In this respect, the multiple different timeframes for which the employee-attrition prediction component 230 is to generate and output predictions may take any of various forms, and in at least some examples, may take the form of different numbers of days or months into the future relative to the time when the prediction is being made (e.g., the current time). For example, the multiple different timeframes for which the employee-attrition prediction component 230 is to generate and output predictions may include a first timeframe comprising a first number of days or months into the future relative to the time when the prediction is being made (e.g., the current time), a second timeframe comprising a second number of days or months into the future relative to the time when the prediction is being made (e.g., the current time), etc.—and one specific implementation of this example would be six different timeframes of one month, two months, three months, four months, five months, and six months into the future relative to the time when the prediction is being made (e.g., the current time). However, the multiple different timeframes for which the employee-attrition prediction component 230 is to generate and output predictions may take other forms as well—including, but not limited to, the possibility that the starting point of at least certain of the timeframes differs from the time when the prediction is being made (e.g., the multiple different timeframes could be defined such that the second timeframe starts at the point that the first timeframe ends, the third timeframe starts at the point that the second timeframe ends, and so on).

In this second implementation, the form of each such prediction may comprise a binary indicator of whether or not a respective employee is likely to leave within the applicable timeframe in the foreseeable future (e.g., a 0/1 value or a no/yes value) or a numeric value that quantifies a likelihood that the respective employee is likely to leave within the applicable timeframe in the foreseeable future (e.g., a value from 0 to 1 or from 0 to 100), among other possibilities. To illustrate with a simplified example, if the given set of employees includes three employees, then the employee-attrition prediction component 230 may function to generate and output three different sets of predictions for the three employees that each include predictions for multiple different timeframes in the future (e.g., timeframes of one month, two months, three months, four months, five months, and six months into the future relative to the time when the prediction is being made): (i) a first set of predictions of whether a first employee is likely to leave the employer within each of multiple different timeframes in the foreseeable future, (ii) a second set of predictions of whether a second employee is likely to leave the employer within each of the multiple different timeframes in the foreseeable future, and (iii) a third set of predictions of whether a third employee is likely to leave the employer within each of the multiple different timeframes in the foreseeable future.

In this second implementation, the employee-attrition prediction component 230 may generate and output the sets of predictions for employees using one or more data science models, which may take any of various forms. For instance, as one possibility, the employee-attrition prediction component 230 may utilize a set of multiple AI models that are each configured to (i) receive feature data for an employee that comprises values for a respective set of feature variables that define the AI model's input, and (ii) based on an evaluation of the feature data, generate and output a prediction of whether the employee is likely to leave the employer within a respective timeframe in the future. Or in other words, the employee-attrition prediction component 230 may utilize a set of multiple AI models that includes a first AI model that is configured to predict whether an employee is likely to leave the employer within a first timeframe in the future, a second AI model that is configured to predict whether an employee is likely to leave the employer within a second timeframe in the future, and so on for any other timeframes for which the employee-attrition prediction component 230 is to generate and output predictions. To illustrate with one possible example, such a set of multiple AI models may include (i) a first AI model that is configured to predict whether an employee will leave the employer within one month relative to the time of the prediction, (ii) a second AI model that is configured to predict whether an employee will leave the employer within two months relative to the time of the prediction, (iii) a third AI model that is configured to predict whether an employee will leave the employer within three months relative to the time of the prediction, (iv) a fourth AI model that is configured to predict whether an employee will leave the employer within four months relative to the time of the prediction, (v) a fifth AI model that is configured to predict whether an employee will leave the employer within five months relative to the time of the prediction, and (vi) a sixth AI model that is configured to predict whether an employee will leave the employer within six months relative to the time of the prediction, among other possible examples of AI models that may be included in the set of multiple AI models. Each of the AI models included in such a set of multiple AI models may take any of various forms.

To begin, the respective set of feature variables that define each AI model's input may include any of various types of feature variables that may be predictive of whether the respective employee is likely to leave the employer within the given timeframe in the future), including, but not limited to, any of various types of feature variables described above. In this respect, it should be understood that the respective set of feature variables for each AI model either may include the same feature variables or may include different feature variables. For example, an AI model that is configured to predict whether an employee will leave the employer within one timeframe may have a different set of feature variables than an AI model that is configured to predict whether an employee will leave the employer within a different timeframe, which may be the case in a scenario where some feature variables are more predictive of employee attrition within one timeframe while other feature variables are more predictive of employee attrition within a different timeframe.

Further, in line with the discussion above, the prediction that is generated and output by each such AI model may take the form of a binary indicator of whether or not an employee is likely to leave within the respective timeframe in the future (e.g., a 0/1 value or a no/yes value) or a numeric value that qualifies a likelihood that the employee is likely to leave within the respective timeframe in the future (e.g., a value from 0 to 1 or from 0 to 100), among other possibilities.

Further yet, each such AI model may take any of various forms, including but not limited to any of various forms of AI models that are created utilizing a machine-learning process that involves one or more machine learning techniques, examples of which may include a regression model, a decision-tree-based model (e.g., a gradient boosting model, random forest model, etc.), a SVM-based model, a Bayesian model, a kNN model, a Gaussian process model, a deep learning model (e.g., a feedforward, recurrent, or convolutional neural-network model, a GAN model, an autoencoder-based model, a transformer-based model, etc.), a clustering model, an association-rule model, a dimensionality-reduction model, and/or a reinforcement-learning model, among other possible examples of AI models that can be created using machine learning techniques.

In practice, the process of creating each such AI model using a machine-learning process may involve (i) obtaining a training dataset for training the AI model, which may comprise data records for employees that include values for the given set of feature variables (and perhaps other candidate feature variables) at certain reference times in the past and perhaps also ground-truth values indicating whether or not the employees left the employer within some timeframe after the reference times that corresponds to the AI model's respective timeframe in the future (e.g., one or more months after the reference times), and then (ii) applying a machine-learning process (e.g., a process involving supervised, semi-supervised, and/or unsupervised machine learning techniques) to the training data one or more times in order to train one or more instances of the AI model (sometimes referred to as a “model objects”). Further, in scenarios where a single instance of the AI model is trained, the process of creating the AI model may additionally involve validating the performance of the AI model against some threshold level of performance utilizing a validation dataset (or sometimes referred to as a “test dataset”) that has a similar form to the generated training dataset. Alternatively, in scenarios where multiple instances of the AI model are trained (e.g., through the use of different sets of hyperparameters), the process of creating the AI model may additionally involve comparing the performance of the multiple instances of the AI model utilizing a validation dataset (sometimes referred to as a “test dataset”) that has a similar form to the generated training dataset and then selecting the instance of the AI model having the best performance. The process of creating an AI model may take various other forms as well.

In this second implementation, the functionality for generating and outputting a set of timeframe-specific predictions for an employee may take other forms as well.

In this second implementation where the employee-attrition prediction component 230 functions to generate and output predictions of whether employees are likely to leave the employer within each of multiple different timeframes in the foreseeable future, the employee-attrition prediction component 230 may also optionally carry out functionality for combining a set of timeframe-specific predictions for an employee into a single, aggregated prediction of whether the employee is likely to leave the employer within the foreseeable future. This functionality may take any of various forms.

As one possibility, after obtaining a set of multiple timeframe-specific predictions for an employee (e.g., using a set of multiple AI models), the employee-attrition prediction component 230 begin by evaluating whether any of the timeframe-specific predictions indicate that the employee is likely to leave at some point in the foreseeable future. For example, if the timeframe-specific predictions take the form of binary indicators of whether or not the employee is likely to leave within the applicable timeframes, the employee-attrition prediction component 230 may determine which of the timeframe-specific predictions have a binary value associated with the employee leaving (e.g., a value of 1 or “yes”). As another example, if the timeframe-specific predictions take the form of numeric values quantifying likelihoods that the employee is likely to leave within the applicable timeframes, the employee-attrition prediction component 230 may determine which of the timeframe-specific predictions have a value that satisfies a condition (e.g., if the value is a probability, the condition could be that the value is greater than or equal to a threshold probability).

If none of the timeframe-specific predictions indicate that the employee is likely to leave at some point in the foreseeable future, the employee-attrition prediction component 230 may aggregate the timeframe-specific predictions for the employee into an aggregated prediction that the employee is not likely to leave the employer within the foreseeable future. Alternatively, if one or more of the timeframe-specific predictions indicate that the employee is likely to leave at some point in the foreseeable future, the employee-attrition prediction component 230 may aggregate the timeframe-specific predictions for the employee into an aggregated prediction that the employee is likely to leave the employer at some point in the foreseeable future, and in some examples, the aggregated prediction may additionally include an indication of when the employee is expected to leave the employer, which may be determined by the employee-attrition prediction component 230 in any of various manners.

As one possible option, the employee-attrition prediction component 230 may determine the indication of when the employee is expected to leave the employer by determining the most near-term timeframe for which the timeframe-specific prediction indicates that the employee is likely to leave. For example, if the employee is predicted to leave in both a one-month timeframe and a two-month timeframe after the time of the prediction, the employee-attrition prediction component 230 may determine that the employee is expected to leave the employer within the one-month timeframe and then use that as the basis for determining the indication of when the employee is expected to leave the employer.

As one possible option, the employee-attrition prediction component 230 may determine the indication of when the employee is expected to leave the employer by determining the timeframe associated with the timeframe-specific prediction that indicates a highest likelihood of the employee leaving the employer. For example, if the employee is predicted to have a 75% chance of leaving within a one-month timeframe after the time of the prediction and a 80% chance of leaving within a two-month timeframe after the time of the prediction, the employee-attrition prediction component 230 may determine that the employee is expected to leave the employer within the two-month timeframe and then use that as the basis for determining the indication of when the employee is expected to leave the employer.

The indication of when the employee is expected to leave the employer may take various other forms and be determined in various other manners as well—including, but not limited to, the possibility that the indication of when the employee is expected to leave the employer may identify multiple timeframes within which the employee is expected to leave.

The aggregated prediction for an employee may take other forms as well, including, but not limited to, the possibility that the aggregated prediction may comprise a vector that includes the timeframe-specific predictions, where the position of each respective value in the vector may represent the timeframe-specific prediction for a respective timeframe (e.g., the respective prediction value for one month may be in a first position, the respective prediction value for two months may be in a second position, and so forth). The aggregated prediction for the employee may also take other forms.

As noted above, once the employee-attrition prediction component 230 has determined the respective predictions for the employees, the employee-attrition prediction component 230 may pass the employee-attrition predictions to other components of the pipeline that are configured to use the employee-attrition predictions as a basis for performing other functions that help to reduce the extent and/or impact of future employee attrition.

The explainability component 240 may function to generate explanations for at least a subset of the employee-attrition predictions that are generated and output by the employee-attrition prediction component 230 (e.g., predictions that an employee is likely to leave within the foreseeable future) and then pass the generated explanations to one or both of (i) the output interface 270 for presentation to a user who wishes to best understand why certain employees are predicted to be at risk of leaving the employer and/or (ii) the retention-recommendation component 250 (e.g., to help the retention-recommendation component 250 identify retention strategies for employees, teams, and/or departments). This function of generating explanations for employee-attrition predictions may take any of various forms.

For instance, in implementations where the employee-attrition predictions are generated using one or more AI models, the function of generating explanations for an employee-attrition prediction may involve utilizing a model explainability technique (sometimes referred to as a model interpretability technique) to quantify the contributions of the feature variables that define the AI model's input to a particular prediction that is generated and output by the AI model. In other words, the model explainability technique may determine an extent to which each of the AI model's feature variables influences a particular prediction that is generated and output by the AI model. For instance, if an AI model receives a data record for a given employee comprising employee-specific feature values for a set of feature variables and then generates and outputs a prediction that the given employee is likely to leave the employer, the explainability component 240 may utilize a model explainability technique to quantify the contributions of the different feature variables to the prediction, where some of the feature variables may have had a larger impact on the AI model's prediction that the given employee is likely to leave the employer while others of the feature variables may have had a smaller impact on the AI model's prediction that the given employee is likely to leave the employer. In this respect, the contributions of the feature variables to the prediction could be quantified in terms of a set of contribution values (or “scores”) for the feature variables.

To illustrate with a simplified example, consider an example AI model that is configured to receive input values for three feature variables: (1) annual salary, (2) commuting distance, and (3) tenure. If this example AI model receives a data record for an employee comprising values for these three data variables and then generates and outputs a prediction that the employee is likely to leave the employer within the foreseeable future, the explainability component 240 may then utilize a model explainability technique to quantify the contributions of the three feature variables to that prediction in terms of a first contribution value for the first feature variable, a second contribution value for the second feature variable, and a third contribution value for the third feature variable. In this respect, the contribution values may indicate which of the three feature variables had the most influence on the prediction that the employee is likely to leave the employer within the foreseeable future.

In these implementations, the explainability technique that is utilized to quantify the contributions of an AI model's input variables may take any of various forms. Some examples of explainability techniques include Local Interpretable Model-agnostic Explanations (LIME), plot-based explainer techniques (e.g., Partial Dependence Plots (PDP), Individual Conditional Expectation (ICE) plots, Accumulated Local Effects (ALE), etc.), and game-theoretic explainability techniques (e.g., techniques that determine or approximate Shapley values, Owen values, or Banzhaf-Owen values, etc.). The explainability technique may also take other forms.

Using the foregoing functionality, the explainability component 240 may determine a set of feature contribution values for each employee in the given set that is predicted to leave the employer within the foreseeable future (or at least a subset thereof).

Using the foregoing functionality, the explainability component 240 may determine a set of feature contribution values for each employee in the given set that is predicted to leave the employer within the foreseeable future (or at least a subset thereof). The sets of feature contribution values—and the functionality carried out by the explainability component 240 to determine the sets of feature contribution values—may take any of various forms.

For instance, in a first implementation, sets of feature contribution values that are determined and output by the explainability component 240 may take the form of respective sets of feature contribution values for predictions of whether employees are likely to leave the employer within a given timeframe in the foreseeable future, such as within some number of days or months in the future (e.g., within the next month, the next two months, etc.) relative to the time when the prediction is being made (e.g., the current time). In the first implementation, the employee-attrition prediction component 230 may utilize a single AI model to make a single respective prediction for each employee (e.g., as described above with respect to the first implementation for the employee-attrition prediction component 230). Accordingly, for each respective prediction, the explainability component may determine a respective set of feature contribution values based on the feature values for the employee and based on the single AI model. In the first implementation, then, each employee may correspond to one respective prediction and to one respective set of feature contribution values. That respective set of feature contribution values may be utilized as the set of feature contribution values for the employee.

In a second implementation, the employee-attrition prediction component 230 may utilize multiple AI models to make multiple respective employee-attrition predictions for multiple timeframes (e.g., as described above with respect to the second implementation for the employee-attrition prediction component 230). As a result, in the second implementation, each employee corresponds to multiple predictions—one for each of the multiple timeframes. In this second implementation, the manner in which the explainability component 240 determines the set of feature contribution values for an employee may take any of various forms.

For instance, as one possibility, the explainability component 240 may, for a given employee, begin by identifying which of the predictions for the given employee indicate that the given employee will leave the employer. Next, the explainability component 240 may compare the respective timeframes to identify by determining the most near-term timeframe for which the corresponding identified prediction indicates that the employee is likely to leave. The explainability component 240 may determine the set of feature contribution values based on the feature values for the given employee and based on the AI model that was used to generate the prediction corresponding to the most near-term timeframe.

As another possibility, the explainability component 240 may, for a given employee, begin by identifying which of the predictions for the given employee indicate that the given employee will leave the employer. Next, the explainability component 240 may determine a respective set of feature contribution values for each identified prediction based on the feature values for the given employee and based on the respective AI model that was used to generate the identified prediction. The explainability component 240 may then aggregate the respective sets of feature contribution values into set of aggregated feature contribution values. The set of aggregated feature contribution values may be utilized as the set of feature contribution values for the given employee.

The manner in which the explainability component 240 determines the set of feature contribution values may also take other forms.

Further, after determining the feature contribution values at an employee level, then for each respective employee that is predicted to leave (or a least a subset thereof), the explainability component 240 may utilize the respective employee's feature contribution values to identify a set of influencing features that appear to be the most significant drivers for why the employee may leave. In this respect, the feature contribution values and the set of influencing features may vary from one employee to another. To illustrate with a simplified example, let a first feature variable represent a commuting distance (e.g., from a home address to an office address) and let a second feature variable represent an annual salary. Let a first data record represent a first employee who has a relatively long commuting distance (e.g., fifty miles) and who receives a relatively high annual salary (e.g., $400,000). Further, let a second data record represent a second employee who has a relatively short commuting distance (e.g., a quarter of a mile) and a relatively low annual salary (e.g., $18,000). In this example, an AI model included in the employee-attrition prediction component 230 may predict that both the first employee and the second employee will leave the employer within six months. However, the extent to which the commuting distance and the annual salary influence the respective predictions for the first employee and the second employee may differ. Specifically, the first employee may be predicted to leave because of the commuting distance and in spite of (rather than because of) the annual salary. By contrast, the second employee may be predicted to leave because of the annual salary in spite of (rather than because of) the commuting distance. These differences in the underlying reasons why the first employee and the second employee are predicted to leave may be reflected by differences in the contribution values for the commuting distance and the annual salary. Specifically, for the first data record (which represents the first employee), the contribution value for commuting distance may be high (e.g., one on a scale from zero to one, where increases in contribution values indicate increases in influence), while the contribution value for annual salary may be low. By contrast, for the second data record (which represents the second employee), the contribution value for the commuting distance may be low and the contribution value for annual salary may be high.

Other examples involving other types of feature variables are also possible.

Further yet, after determining the feature contribution values at an employee level, the explainability component 240 may also optionally function to aggregate the employee-level feature contribution values across multiple different employees—such as multiple employees that are considered to be part of a same group.

This function of generating explanations for employee-attrition predictions may take other forms as well.

By generating explanations for employee-attrition predictions at an employee level and/or a group level, the explainability component 240 extracts meaning that may be presented to a user via the output interface 270 and/or may be utilized by the retention-recommendation component 250 to generate retention strategies that are tailored to specific employees and/or groups of employees (e.g., as described below).

Referring back to FIG. 2, the retention-recommendation component 250 may function to generate respective retention strategies for certain employees (and/or groups of employees) and then pass the generated retention strategies to the output interface 270 for presentation to a user to facilitate effectuating those retention strategies preemptively so that at least some employees who have been predicted to leave might be persuaded to stay with the employer.

As used herein, a retention strategy for a given employee refers to a set of one or more actions that the employer may take to reduce the likelihood that the given employee will leave, and a retention strategy for a given group of employees refers to a set of one or more actions that the employer may take to reduce the likelihood that one or more employees in the given group will leave. The types of actions that may be included in a retention strategy may take various forms.

For instance, as one possibility, a retention strategy may include remunerative actions such as increasing one or more types of compensation (e.g., increasing a salary, increasing an hourly rate, increasing a commission percentage, providing a monetary bonus, etc.), enhancing one or more benefits (e.g., providing additional options for insurance plans and/or carriers, providing additional paid time off, increasing 401k matching percentages, providing child care benefits, providing stock options, etc.), and/or providing one or more perks (e.g., providing discounts on company and/or third-party products and/or services, providing company vehicles, providing company phones, providing company credit cards, providing hybrid or work-from-home options, etc.). Other types of remunerative actions may also be included in a retention strategy.

As another possibility, a retention strategy may include training actions such as providing technical training (e.g., in how to use physical tools, electronic devices, and/or software applications that employees use to do their jobs), providing compliance training (e.g., to educate employees about legal standards and industry standards pertinent to their jobs), providing leadership training (e.g., training employees how to manage other employees), providing product/service training (e.g., to familiarize employees with the products and services that the employer provides to customers), sales training (e.g., teaching effective tactics for initiating and closing sales), cross-departmental training (e.g., training employees to do types of work outside of their usual job responsibilities to facilitate collaboration across departments and flexibility in the types of jobs that employees can perform), and/or sensitivity training (e.g., training employees in office etiquette to ensure that the employer provides a work environment that is professional, welcoming, and/or inclusive for people with different backgrounds). Other types of training actions may also be included in a retention strategy.

As yet another possibility, a retention strategy may include workload-calibration actions such as adjusting thresholds for performance metrics (e.g., reducing a threshold number of sales to be made to qualify for bonuses), hiring additional employees to share a workload currently assigned to a given employee (or group of employees), adjusting a deadline for completion of a goal (e.g., pushing back a deadline for releasing a product under development), providing additional resources to assist in performing job duties (e.g., increasing a budget that employees can use to purchase and/or maintain tools, machines, and/or software for doing their jobs more efficiently), reducing an amount of travel assigned to an employee (or group of employees), and/or reassigning a portion of a workload from one employee (or group of employees) to another employee (or group of employees). Other types of workload-calibration actions may also be included in a retention strategy.

As yet another possibility, a retention strategy may include career-progression actions such as offering promotions, providing opportunities to travel to career-related events (e.g., conferences), providing publishing opportunities (e.g., allowing employees to write articles for submission to peer-reviewed journals), providing competition opportunities (e.g., allowing employees to create and submit entries for engineering competitions), and/or providing innovation opportunities (e.g., conducting hackathons and brainstorming sessions). Other types of career-progression actions may also be included in a retention strategy.

As yet another possibility, a retention strategy may include feedback-based actions such as conducting surveys (e.g., asking employees to explain the problems they regularly encounter during the course of their jobs and what the employer could provide to mitigate those problems), conducting sessions with focus groups (e.g., groups of employees selected from departments of interest), and/or taking action in response to received feedback (e.g., implementing process changes suggested by employees, removing obstacles that employees have identified as impeding their work, etc.). Other types of feedback-based actions may also be included in a retention-strategy.

The types of actions that may be included in a retention strategy may also take other forms.

Further, at a high level, the function of generating a retention strategy for an employee (or group of employees) may involve evaluating a source dataset associated with the employee (or group of employees) in order to determine which actions to include as part of the retention strategy. In this respect, the source dataset may include employee-related data (e.g., as described above with respect to the input interface 210), feature data (e.g., as described above with respect to the data-preparation component 220), and/or feature contribution values (e.g., as described above with respect to the explainability component 240), among other possibilities, and the evaluation that is performed on the source dataset may take any of various forms. In one implementation, the function of evaluating a source dataset associated with a given employee (or group of employees) in order to determine which actions to include as part of the retention strategy may involve comparing the source dataset associated with the given employee (or group of employees) to a relation that comprises a plurality of conditions. The relation may associate each condition included therein with a respective set of actions for the retention-recommendation component 250 to recommend when the condition is satisfied. Accordingly, for each condition, the retention-recommendation component 250 may (i) determine, based on the comparison to the source data, whether the condition is satisfied and (ii) if the condition is satisfied, add actions included in the respective set to the retention strategy. (Note that, if a given action included in the respective set of actions has already been added to the retention strategy by virtue of being associated with another condition in the relation, the given action does not have to be added to the retention strategy again.)

As one example of a set of actions that a relation may associate with a condition, consider a scenario in which a condition is that the contribution value for a feature variable representing commuting distance exceeds a predefined threshold contribution value. In this scenario, the set of actions associated with the condition may comprise offering an option to work remotely to the employee (or group of employees) for whom a retention strategy is being generated. If the condition is satisfied, the retention-recommendation component 250 may be configured to add the action of offering the option to work remotely to the retention strategy for the employee (or group of employees). As another example of a set of actions that a relation may associate with a condition, consider a scenario in which a condition is that an annual salary of the employee (or the average annual salary of a group of employees) is less than a predefined threshold salary. In this scenario, the set of actions associated with the condition may comprise offering a raise equal to a predefined percentage of the annual salary (or average annual salary). If this condition is satisfied, the retention-recommendation component 250 may be configured to add the action of offering the raise to the retention strategy for the employee (or group of employees). Many other examples of conditions (including compound conditions that are combinations of multiple individual conditions) and associated sets of actions are also possible.

In another implementation, the function of evaluating a source dataset associated with a given employee (or group of employees) in order to determine which actions to include as part of the retention strategy may involve evaluating the source dataset using one or more AI models. The one or more AI models may take any of various forms.

As one possibility, the one or more AI models that are utilized to generate a retention strategy may comprise a set of discriminative AI models, each of which corresponds to a respective action and is configured to (i) receive the source dataset or a portion thereof (e.g., in the form of data records that represent employees and/or respective sets of contribution values for those data records) as input and (ii) output an indication (e.g., a binary indication) of whether to add the respective action to a retention strategy for the employee (or group of employees). In this respect, each such discriminative AI model may take any of various forms, including but not limited to any of various forms of AI models that are created utilizing a machine-learning process that involves one or more machine learning techniques, examples of which may include a regression model, a decision-tree-based model (e.g., a gradient boosting model, random forest model, etc.), a SVM-based model, a Bayesian model, a kNN model, a Gaussian process model, a deep learning model, a clustering model, an association-rule model, a dimensionality-reduction model, and/or a reinforcement-learning model, among other possible examples of AI models that can be created using machine learning techniques. Further, in practice, the process of creating each such discriminative AI model using a machine-learning process may be similar to the model creation process described previously in the context of the AI models utilized by the employee-attrition prediction component 230.

As an illustrative example of the how discriminative AI models may operate, consider a scenario in which a first discriminative AI model is configured to determine whether to include the action of offering an option to work from home. In this scenario, a second discriminative AI model may be configured to determine whether to include the action of offering a raise. For a first employee who has a relatively high salary and a relatively long commuting distance (e.g., as described in an example above with respect to the explainability component 240), the first discriminative AI model may output an indication (e.g., a binary value of “1” or “true”) that the action of offering an option to work from home should be included in a retention strategy for the first employee. For a second employee who has a relatively short commuting distance and a relatively low annual salary, the first discriminative AI model may output an indication (e.g., a binary value of “0” or “false”) that the action of offering an option to work from home should not be included in a retention strategy for the second employee. By contrast, the second discriminative AI model may output an indication that the action of offering a raise should not be added to the retention strategy for the first employee. The second discriminative AI model may further output an indication that the action of offering a raise should be added to the retention strategy for the second employee. In this manner, the first and second discriminative AI models may be used to respective retention strategies that are specifically tailored to the first employee and the second employee, respectively.

As another possibility, the one or more AI models that are utilized to generate a retention strategy may comprise a generative AI model that is configured to (i) receive a prompt comprising a request to generate a retention strategy based on the source dataset and (ii) generate the retention strategy. Such a generative AI model may take any of various forms, such as a transformer-based model (e.g., a large language and/or large multimodal model), a diffusion model, a generational adversarial network, and/or a variational autoencoder, among other possibilities. In practice, the generative AI model may have been trained via a pre-training technique that may involve unsupervised, semi-supervised, and/or supervised machine learning techniques. Additionally, the generative AI model may also have been further trained via a technique such as fine-tuning (e.g., based on a labeled training set derived from historical data indicating retention strategies that were used in an effort to retain particular employees and whether those particular employees stayed with the employer for an applicable threshold time period). Additionally yet, the generative AI model may optionally be refined via reinforcement learning.

The one or more AI models that are utilized to generate a retention strategy may take other forms as well.

In yet another implementation, the function of evaluating a source dataset associated with a group of employees in order to determine which actions to include as part of the retention strategy may involve determining respective retention strategies for the employees in the group (e.g., using one of the approaches described above) and then applying logic to the respective retention strategies for employees included in the group (i.e., group members). As one example of how such logic may be applied, the retention-recommendation component 250 may identify actions that are included in at least a threshold number of the respective retention strategies for group members and add the identified actions to the retention strategy for the group.

The function of evaluating a source dataset associated with a group of employees in order to determine which actions to include as part of the retention strategy may also take other forms.

As noted above, after the retention strategies have been generated, the retention-recommendation component 250 may pass the retention strategies to the output interface 270 for presentation to a user to facilitate effectuating those retention strategies preemptively.

Referring again back to FIG. 2, the hiring-need component 260 may function to predict preemptively where a hiring need will arise within the employer based on the employee-attrition predictions and then carry out certain actions to help address that predicted hiring need. The manner in which the hiring-need component 260 predicts a hiring need may take any of various forms.

For instance, as one possibility, the hiring-need component 260 may begin by identifying employees whose respective predictions (e.g., as received from the employee-attrition prediction component 230) indicate they are likely to leave the employer within the foreseeable future. For instance, in an implementation where the employee-attrition prediction component 230 generates and outputs a single employee-attrition prediction for each employee, the hiring-need component 260 may identify the employees whose respective predictions indicate they are likely to leave the employer within the foreseeable future based on an evaluation of the single employee-attrition prediction for each employee. Alternatively, in an implementation where the employee-attrition prediction component 230 generates and outputs multiple employee-attrition predictions for each employee that correspond to multiple different timeframes, the hiring-need component 260 may identify the employees whose respective predictions indicate they are likely to leave the employer within the foreseeable future based on an evaluation of either (i) an aggregated prediction that is generated by the employee-attrition prediction component 230 for each employee based on the multiple employee-attribution predictions for the multiple timeframes or (ii) the multiple employee-attribution predictions for each employee (e.g., by evaluating whether any of one the multiple employee-attribution predictions indicates that the employee is likely to leave the employer within the foreseeable future).

Next, the hiring-need component 260 may group the identified employees based on one or more variables that relate to the employees'position within the employer. The one or more variables that are utilized to form the groups may take any of various forms, examples of which may include an employee's department, team, job title, and/or job function, among other possibilities. To illustrate with an example, if the hiring-need component 260 is configured to group the identified employees based on job title, then identified employees having comparable job titles may be grouped together into groups corresponding to those job titles and identified employees that do not have comparable job titles with others may not be grouped together.

Next, the hiring-need component 260 may, based on the groups, identify one or more positions within the employer (e.g., departments, job functions, job titles, and the like) for which a hiring need is predicted to arise in the foreseeable future. For instance, if there is a group of employees having a comparable position within the employer that are predicted to leave within the foreseeable future, the hiring-need component 260 may (i) evaluate whether that group meets certain threshold criteria, such as a threshold number or threshold percentage of employees having that position within the employer, and (ii) if the group meets the threshold criteria, predict that a hiring need is likely to arise for the position. To illustrate with an example, if there is a group of ten employees having a comparable job title (e.g., data scientist) that are predicted to leave within the foreseeable future, the hiring-need component 260 may determine whether that group meets certain threshold criteria for identifying a hiring need for the job title, and, if so, may predict that a hiring need is likely to arise for the job title in the foreseeable future.

As noted above, in some implementations, predictions that the employee-attrition prediction component 230 provides to the hiring-need component 260 may specify timeframes in which employees are predicted to leave the employer. In such implementations, the hiring-need component 260 may account for those timeframes when predicting hiring needs and/or incorporate those timeframes into the predicted hiring needs. For example, consider a scenario in which the predictions may specify one or more of multiple possible timeframes in the future. In this scenario, the hiring-need component 260 may either (i) aggregate the different timeframes together into a single, aggregated timeframe and then perform the foregoing functionality for identifying a hiring need with respect to that aggregated timeframe or (ii) perform the foregoing functionality for identifying a hiring need separately for each of the different timeframes (e.g., by identifying the employees that are predicted to leave the employer within each of the different timeframes separately). The manner in which the hiring-need component 260 accounts for and/or incorporates the respective timeframes into the predicted hiring needs may also take other forms.

The manner in which the hiring-need component 260 predicts hiring needs may also take forms.

After identifying the one or more positions within the employer (e.g., departments, teams, job functions, job titles, and the like) for which a hiring need is predicted to arise in the foreseeable future, the hiring-need component 260 may perform any of various actions for addressing each such hiring need.

For instance, as one possibility, an action for addressing a hiring need may comprise causing the back-end computing platform 102 to present an alert to a user that is tasked with addressing the hiring need (e.g., a supervisor and/or an HR employee). For example, the hiring-need component 260 may send a message to the output interface 270 that instructs the output interface 270 to output an alert that is to be presented to the user. Such an alert may include an identification of the position within the employer where the hiring need is predicted to arise and perhaps also other information that may be utilized to address the predicted hiring need (e.g., information about the position).

As another possibility, an action for addressing a hiring need may comprise initiating a workflow for posting a job listing for the position within the employer where the hiring need is predicted to arise. The form in which the hiring-need component 260 initiates the workflow may take various forms. For instance, as one example, the hiring-need component 260 may cause a job listing entry to be created that is pre-populated with certain information for the position, and that job listing entry may then be presented to a user that is tasked with addressing the hiring need (e.g., a supervisor and/or an HR employee).

As yet another possibility, an action for addressing a hiring need may comprise automatically generating a job listing for the position within the employer where the hiring need is predicted to arise. This function of automatically generating the job listing may take any of various forms.

As one option, the hiring-need component 260 may automatically generate the job listing through the use of a generative AI model that is configured to (i) receive a prompt comprising a request to generate a job listing for the position within the employer where the hiring need is predicted to arise and (ii) generate the job listing. Such a generative AI model may take any of various forms, such as a transformer-based model (e.g., a large language and/or large multimodal model), a diffusion model, a generational adversarial network, and/or a variational autoencoder, among other possibilities. In practice, the generative AI model may have been trained via a pre-training phase that may involve unsupervised, semi-supervised, and/or supervised machine learning techniques. Additionally, the generative AI model may also have been further trained via a technique such as fine-tuning (e.g., based on a labeled training set derived from historical data indicating retention strategies that were used in an effort to retain particular employees and whether those particular employees stayed with the employer for an applicable threshold time period). Additionally yet, the generative AI model may optionally be refined via reinforcement learning.

Actions for addressing a hiring need may also take other forms.

The output interface 270 may generally function to cause output data related to employee attrition, retention, and/or hiring needs that is based on the outputs of certain other components of the example software-based pipeline 200 to be presented to a user. The output data that is presented may take any of various forms.

For instance, as one possibility, the output data may comprise an identification of employees that are predicted to leave the employer within the foreseeable future. The identification of an employee predicted to leave may include any of various identifying information for the employee, examples of which may include a name of the employee; an employee identification (ID) number; a job title, department, team, and/or job function of the employee; and/or a pay grade of the employee, among the possibilities.

Along with the identification of the employees that are predicted to leave the employer within the foreseeable future, the output data may also provide other information about the identified employees. For example, the output data may additionally include an indication of when each of the identified employees is expected to leave (e.g., as determined by the employee-attrition prediction component 230 described above). As another example, the output data may additionally include an indication of the top reasons why each of the identified employees is predicted to leave the employer (e.g., as determined by the explainability component 240 described above). As yet another example, the output data may additionally include a retention strategy for each of the identified employees (e.g., as determined by the retention-recommendation component 250 described above). The additional information that is presented along with the identification of the employees that are predicted to leave the employer within the foreseeable future may take other forms as well.

Further, in practice, the identification of the employees that are predicted to leave the employer within the foreseeable future may take any of various forms and be arranged in any of various manners, including, but not limited to, the possibility that the identified employees may be grouped based on their positions within the employer (e.g., based on departments, teams, job titles, job functions, etc.).

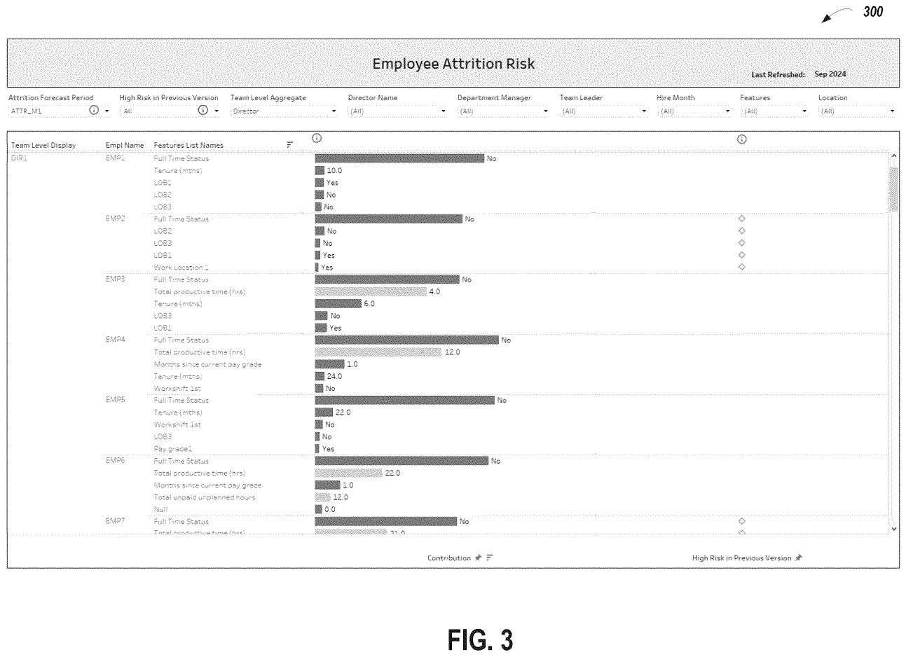

To illustrate, FIG. 3 shows one possible example of a graphical user interface (GUI) visualization 300 that may be presented based on output data from the output interface 270. The example GUI visualization 300 of FIG. 3 is shown to include an identification of certain employees that are predicted to leave the employer within the foreseeable future along with an indication of the top reasons why each of the identified employees is predicted to leave the employer. For example, for the employee identified as “EMP1,” the example GUI visualization 300 shows that the top features impacting the prediction that the employee is expected to leave are full time status, tenure, LOB1, LOB2, and LOB3, where the information presented next to each of these features for the employee includes an indication of the employee's data for these features (e.g., “No” for full time status, 10 months for tenure, etc.) and a bar that indicates the extent to which each such feature contributes to the prediction that the employee is expected to leave.

Further, as shown in FIG. 3, the example GUI visualization 300 may use different colors for the bars to indicate which features are considered to be more “actionable” for purposes of trying to reduce the chances of the employee leaving. For example, for the employee identified as “EMP3,” the example GUI visualization 300 uses a different coloring for the bar next to the total productive time feature (shown in FIG. 3 as a lighter shading rather than a darker shading) to indicate that total productive time is an actionable feature that can be worked on in order to reduce the chances of the employee leaving.

Further yet, although not shown in FIG. 3, the example GUI visualization 300 may present a popup when a given feature-related bar for a given employee is moused over (or clicked) that includes suggested actions for trying to reduce the chances of the employee leaving. For example, for the total productive time feature, the suggested actions that are presented may include suggestions to “identify causes behind unusual working hours through conversations” and/or “manage the workload, training and shrink to better balance the workload,” among other possible examples. In this respect, the suggested actions could be predefined for the feature and/or could be automatically generated by an AI model or the like (e.g., a generative AI model such as a large-language model).

Sill further, as shown in FIG. 3, the example GUI visualization 300 may include an indication of which features for an employee were previously identified as top features for the employee. For example, for the employee identified as “EMP2,” the example GUI visualization 300 shows diamond-shaped indicators for each feature to indicate that each of those features was previously identified as a top feature for the employee.

As another possibility, the output data may comprise group-level explanations for predicted employee attrition that are generated by the explainability component 240, such as group-level explanations for a department, team, job title, job function, etc. of the employer.

As yet another possibility, the output data may comprise a group-level retention strategy that is generated by the retention-recommendation component 250, such as a group-level retention strategy for a department, team, job title, job function, etc. of the employer.

As still another possibility, the output data may comprise an alert and/or a job listing that is generated by the hiring-need component 260.

The output data that is presented by the output interface 270 may also take other forms.

Further, the manner in which the output interface 270 causes the output data to be presented may take any of various forms.

For instance, as one possibility, the output interface 270 may cause a client device associated with a user to display a list of employees who have been predicted to leave the employer in the foreseeable (e.g., by sending an instruction to the client device). In this example, the list may be filtered by department, job title, job function, and/or timeframe in which employees are predicted to leave, among other possibilities. When a user interacting with the list clicks on an employee's name, a retention strategy for the employee may be displayed (e.g., in a message balloon that pops up in response to the click).

As another possibility, the output interface 270 may cause the client device associated with the user to display a dashboard that indicates hiring needs for different departments, job titles, and/or job functions, among other possibilities. Furthermore, when a job title is clicked, a job listing generated for the job title may appear in a sidebar or in a pop-up window. The job listing may be presented in an editable format and with a button to submit the job listing for publication (e.g., to a website for the employer and/or to a third-party job-board website).

As yet another possibility, the output interface 270 may cause the client device associated with the user to display, for an employee that is predicted to leave, a list of feature variables that are ranked according to their respective contribution values for the employee. The respective contribution values may be indicated, for example, by bars (e.g., in a bar graph). Fill and/or outline colors of the bars may indicate additional information. For instance, a first fill color for a bar may indicate that a value of the feature variable corresponding to the contribution value the bar represents may be influenced by one or more actions included in the retention strategy for the employee. By contrast, a second fill color for the bar may indicate that the value of the feature variable is unlikely to be influenced by actions included in the retention strategy.

As yet another possibility, the output interface 270 may cause the client device associated with the user to display a visual indication (e.g., a flag or some other type of visual indication) near the names of employees who were added to the list of employees who are predicted to leave when the list was last updated (e.g., employees who are showing up in the list for the first time).

The manner in which the output interface 270 causes the output data to be presented may also take other forms.

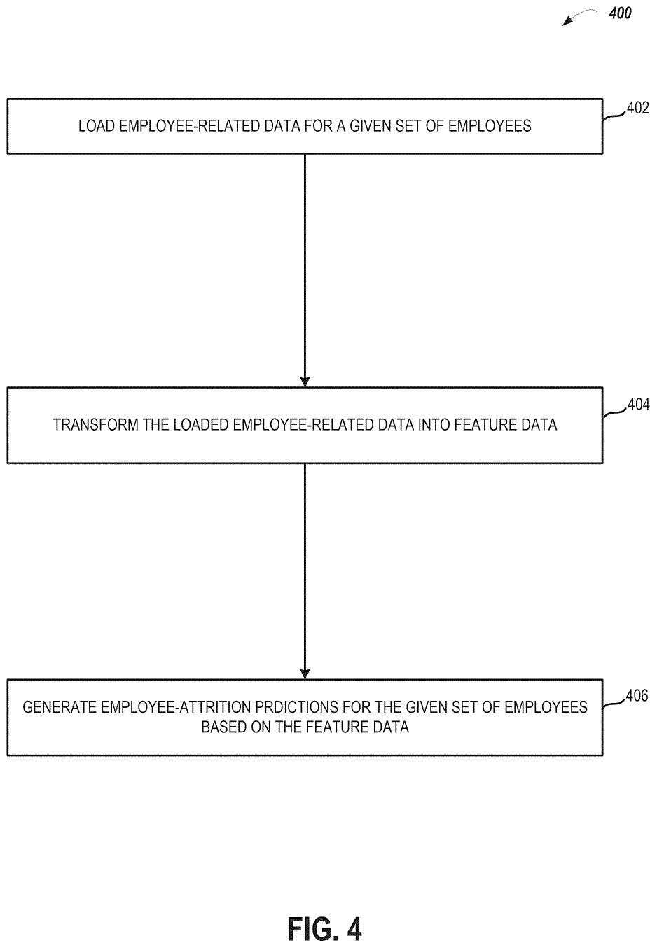

One possible example of functionality 400 that may be carried out in accordance with the disclosed software technology will now be described with reference to the flow chart of FIG. 4. In practice, the functionality 400 of FIG. 4 may be encoded in the form of program instructions that are executable by one or more processors of a computing platform, and for purposes of illustration, the functionality 400 of FIG. 4 is described as being carried out by the back-end computing platform 102 of FIG. 1, but it should be understood that the functionality 400 of FIG. 4 may be carried out by any one or more computing platforms that are capable of being installed with software for performing the functions described below. Further, it should be understood that the functionality 400 of FIG. 4 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

In line with discussion above, the functionality 400 may begin at block 402 with the back-end computing platform 102 loading employee-related data for a given set of employees.

The employee-related data for the given set of employees may take any of various forms. For example, the employee-related data include job description data, remuneration data, personal data, performance data, and/or market data (e.g., as described above with respect to FIG. 2). The employee-related data for the given set of employees may also take other forms.

Further, the function of loading the employee-related data for the given set of employees may take any of various forms. For example, the function of loading the employee-related data for the given set of employees may involve retrieving at least a portion of the employee-related data from a data storage layer of the back-end computing platform 102. As another example, the function of loading the employee-related data for the given set of employees may involve obtaining at least a portion of the employee-related data from one or more data sources that are external to the back-end computing platform 102 (e.g., such as the one or more data sources 104 shown in FIG. 2), such as by causing (e.g., instructing) the back-end computing platform 102 to send a request for employee-related data to a given data source via a network-based communication path and then receiving the employee-related data back from the given data source via the network-based communication path. The given data source may take any of various forms (e.g., as described above with respect to FIG. 2). As yet another example, the function of loading the employee-related data for the given set of employees may involve retrieving a first portion of the employee-related data from a data storage layer of the back-end computing platform 102 and obtaining a second portion of the employee-related data from the one or more data sources. The function of loading the employee-related data for the given set of employees may also take other forms.

At block 404, the back-end computing platform 102 may prepare the loaded employee-related data for input into one or more AI models that are configured to render employee-attrition predictions, such as by transforming the loaded employee-related data into feature data for the one or more AI models. The feature data may, for example, comprise a set of data records such that each data record (i) represents a respective employee in the given set of employees and (ii) includes feature values for respective feature variables in a given set of feature variables. In an implementation where multiple AI models are utilized to render employee-attrition predictions, it is also possible that the feature data may comprise multiple sets of data records for each respective employee that include features values for different sets of feature variables.

The manner in which the back-end computing platform 102 transforms the employee-related data into the feature data may take various forms. For example, to create a data record that represents a given employee, the back-end computing platform 102 may begin by identifying, from the loaded employee-related data, a given set of data associated with the given employee. Next, the back-end computing platform 102 may determine feature values for the given employee that map to the given set of feature variables based on the given set of data associated with the given employee. The data-preparation component 220 may then store the feature values for the given employee together as a given data record that represents the given employee. The manner in which the back-end computing platform 102 transforms the employee-related data into the feature data may also take other forms.

Further, the manner in which the back-end computing platform 102 determines feature values for the given employee based on the given set of data associated with the given employee may take any of various forms. For example, the back-end computing platform 102 may detect a datum in the given set of data that includes information matching a particular feature variable. If the datum is in a format that a schema specifies for the particular feature variable, the back-end computing platform 102 may store the datum as the feature value for the particular feature variable. On the other hand, if the datum is not in the format that the schema specifies for the particular feature variable, the back-end computing platform may perform one or more transformation operations to convert the datum into the format and may then store the transformed datum as the feature value for the particular feature variable. As another example, the back-end computing platform 102 may identify one or more operands in the given set of data that may be used to compute a feature value for a particular feature variable and may utilize the operands to compute the feature value. As yet another example, the back-end computing platform 102 may utilize data found in the given set of data to formulate a request to retrieve additional data for determining the feature value for a particular feature variable (e.g., as described above with respect to FIG. 2). The manner in which the back-end computing platform 102 determines feature values for the given employee based on the given set of data associated with the given employee may also take other forms.

Further yet, the feature variables may take any of various forms. For instance, a feature variable may comprise an indication that is remuneration-based, career-based, location-based, and/or time-based (e.g., such as the indications discussed above with respect to FIG. 2). The feature variables may also take other forms.

At block 406, the back-end computing platform 102 may generate employee-attrition predictions for the given set of employees based on the feature data. The employee-attrition predictions—and the functionality carried out by the back-end computing platform to generate the employee-attrition predictions—may take any of various forms.

For instance, in a first implementation, the employee-attrition predictions may take the form of predictions of whether the employees (that are in the given set of employees) are likely to leave an employer within a given timeframe relative to a time when the employee-attrition predictions are made (e.g., the current time). In this first implementation, the form of each such prediction may comprise a binary indicator of whether or not a respective employee is likely to leave within the given timeframe (e.g., a 0/1 value or a no/yes value) or a numeric value that qualifies a likelihood that the respective employee is likely to leave within the given timeframe (e.g., a value from 0 to 1 or 0 to 100), among other possibilities (e.g., as described above with respect to FIG. 2).

In this first implementation, the back-end computing platform 102 may generate and output such employee-attrition predictions using a data science model, which may take any of various forms. For instance, as one possibility, the back-end computing platform 102 may utilize an AI model that is configured to (i) receive feature data for an employee that comprises values for the given set of feature variables as input, and (ii) based on an evaluation of the feature data, generate and output an employee-attrition prediction that indicates whether the employee is likely to leave the employer within the given timeframe. Such an AI model may take any of various forms and may have been created by applying a machine-learning process to a training dataset (e.g., as described above with respect to FIG. 2). In this first implementation, the functionality for generating and outputting employee-attrition predictions may take other forms as well.

In a second implementation, the employee-attrition predictions that are generated and output by the back-end computing platform 102 may take the form of predictions of whether employees (that are in the given set of employees) are likely to leave the employer within each of multiple different timeframes in the future. For instance, for each respective employee (in the given set of employees), the back-end computing platform 102 may generate and output a respective set of employee-attrition predictions for the respective employee. Each respective set of employee-attrition predictions may comprise a first employee-attrition prediction of whether the respective employee is likely to leave the employer within a first timeframe in the future, a second first employee-attrition prediction of whether the respective employee is likely to leave the employer within a second timeframe in the future, and so on for any other timeframes for which the back-end computing platform 102 is configured to generate and output employee-attrition predictions. In this respect, the multiple different timeframes for which the back-end computing platform 102 is configured to generate and output predictions may take any of various forms, and in at least some examples, may take the form of different numbers of days or months into the future relative to the time when the first employee-attrition predictions are being made (e.g., as described above with respect to FIG. 2). The multiple different timeframes for which the back-end computing platform 102 generates and outputs first employee-attrition predictions may take other forms as well (e.g., as described above with respect to FIG. 2).

In this second implementation, the form of each such employee-attrition prediction may comprise a binary indicator of whether or not a respective employee is likely to leave within the applicable timeframe (e.g., a 0/1 value or a no/yes value) or a numeric value that quantifies a likelihood that the respective employee is likely to leave within the applicable timeframe (e.g., a value from 0 to 1 or from 0 to 100), among other possibilities.

In this second implementation, the back-end computing platform 102 may generate and output the respective sets of employee-attrition predictions using one or more data science models, which may take any of various forms. For instance, as one possibility, the back-end computing platform 102 may utilize a set of multiple AI models that are each configured to (i) receive feature data for an employee that comprises values for a respective set of feature variables (which may be the given set of feature variables or a subset thereof) that define the AI model's input, and (ii) based on an evaluation of the feature data, generate and output an employee-attrition prediction of whether the employee is likely to leave the employer within a respective timeframe in the future. Or in other words, the back-end computing platform 102 may utilize a set of multiple AI models that includes a first AI model that is configured to predict whether an employee is likely to leave the employer within a first timeframe in the future, a second AI model that is configured to predict whether an employee is likely to leave the employer within a second timeframe in the future, and so on for any other timeframes for which the back-end computing platform 102 is to generate and output predictions. Each of the AI models included in such a set of multiple AI models may take any of various forms.

To begin, the respective set of feature variables that define each AI model's input may include any of various types of feature variables that may be predictive of whether the respective employee is likely to leave the employer within the given timeframe in the future, including, but not limited to, any of various types of feature variables described above. In this respect, it should be understood that the respective set of feature variables for each AI model either may include the same feature variables or may include different feature variables. For example, an AI model that is configured to predict whether an employee will leave the employer within one timeframe may have a different set of feature variables than an AI model that is configured to predict whether an employee will leave the employer within a different timeframe (e.g., the respective sets of feature variables for different AI models may be different subsets of the given set of feature variables generated in block 404).

Further, in line with the discussion above, the employee-attrition prediction that is generated and output by each such AI model may take the form of a binary indicator of whether or not an employee is likely to leave within the respective timeframe in the future (e.g., a 0/1 value or a no/yes value) or a numeric value that qualifies a likelihood that the employee is likely to leave within the respective timeframe in the future (e.g., a value from 0 to 1 or from 0 to 100), among other possibilities.

Further yet, each such AI model may take any of various forms and may have been created by applying a machine-learning process to a training dataset (e.g., as described above with respect to FIG. 2). In this second implementation, the functionality for generating and outputting a set of timeframe-specific predictions for an employee may take other forms as well.

In this second implementation where the back-end computing platform 102 functions to generate and output employee-attrition predictions of whether employees are likely to leave the employer within each of multiple different timeframes in the foreseeable future, the back-end computing platform 102 may also optionally carry out functionality for combining a set of timeframe-specific predictions for an employee into a single, aggregated prediction of whether the employee is likely to leave the employer within the foreseeable future. This functionality may take any of various forms (e.g., as described above with respect to FIG. 2).

Optionally, in addition to the blocks 402-406, the functionality 400 may include additional functions. Such additional functions may take any of various forms.

For instance, the functionality 400 may include generating respective explanations for at least a subset of the employee-attrition predictions. The function of generating the respective explanations for employee-attrition predictions may take any of various forms (e.g., as explained above with respect to the explainability component 240 of FIG. 2).

Further, the functionality 400 may include generating respective retention strategies for employees (and/or groups of employees) in the given set of employees who are predicted to leave the employer. The types of actions that may be included in a retention strategy and the manner of determining which actions to in a retention strategy may take any of various forms (e.g., as described above with respect to the retention-recommendation component 250 of FIG. 2).

Further yet, the functionality 400 may include predicting one or more hiring needs based on the employee-attrition predictions and/or carrying out one or more actions in response to the predicted one or more hiring needs. The manner in which the back-end computing platform 102 predicts the one or more hiring needs and/or carries out the one or more actions may take any of various forms (e.g., as described above with respect to the hiring-need component 260 of FIG. 2).

Further yet, the functionality 400 may include causing output data related to employee attrition, retention, and/or hiring needs that is based on the employee-attrition predictions, the respective explanations, the one or more hiring needs, and/or the one or more actions (that are to be carried out in response to the one or more hiring needs) to be presented to a user. The output data that is presented may take any of various forms (e.g., as described above with respect to the output interface 270 of FIG. 2).

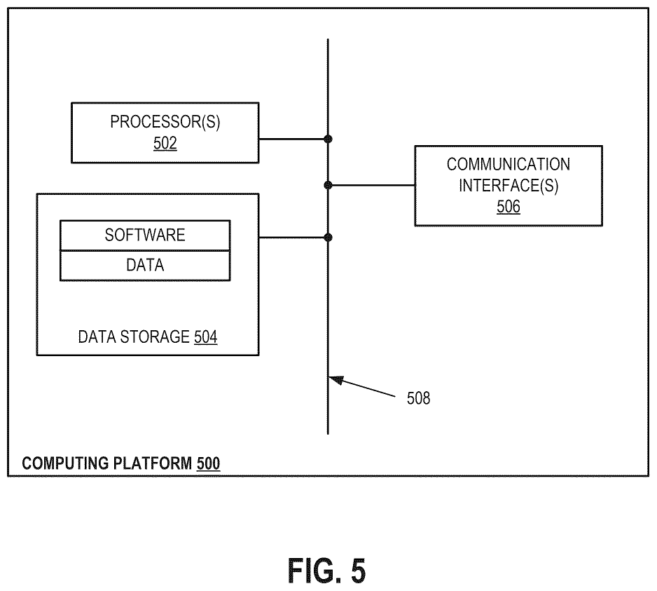

Turning now to FIG. 5, a simplified block diagram is provided to illustrate some structural components that may be included in an example computing platform 500 that may be configured to perform some or all of the platform functions disclosed herein. At a high level, the example computing platform 500 may generally comprise any one or more computer systems (e.g., one or more servers) that collectively include one or more processors 502, data storage 504, and one or more communication interfaces 506, all of which may be communicatively linked by a communication link 508 that may take the form of a system bus, a communication network such as a public, private, or hybrid cloud, or some other connection mechanism. Each of these components may take various forms.

For instance, the one or more processors 502 may comprise one or more processor components, such as one or more central processing units (CPUs), graphics processing unit (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 502 could comprise processing components that are distributed across a plurality of physical computing devices connected via a network, such as a computing cluster of a public, private, or hybrid cloud.

In turn, the data storage 504 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 504 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 5, the data storage 504 may be capable of storing both (i) program instructions that are executable by the one or more processors 502 such that the example computing platform 500 is configured to perform any of the various functions disclosed herein (including but not limited to any of the platform functions discussed above), and (ii) data that may be received, derived, or otherwise stored by the example computing platform 500.

The one or more communication interfaces 506 may comprise one or more interfaces that facilitate communication between the example computing platform 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 500 may additionally have an I/O interface that includes or provides connectivity to I/O components that facilitate user interaction with the example computing platform 500, such as a keyboard, a mouse, a trackpad, a display screen, a touch-sensitive interface, a stylus, a virtual-reality headset, and/or one or more speaker components, among other possibilities.

It should be understood that the example computing platform 500 is one example of a computing platform that may be used with the embodiments described herein. Numerous other arrangements are possible and contemplated herein. For instance, in other embodiments, the example computing platform 500 may include additional components not pictured and/or more or less of the pictured components.

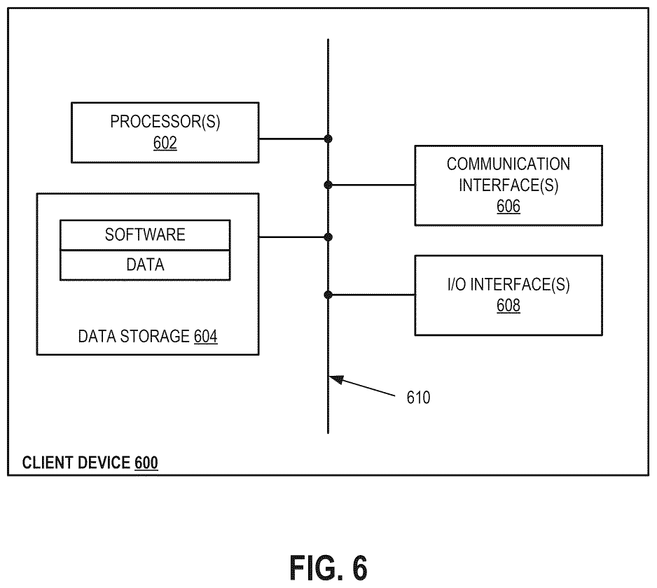

Turning next to FIG. 6, a simplified block diagram is provided to illustrate some structural components that may be included in an example client device 600 that may be configured to perform some or all of the client-device functions disclosed herein. At a high level, the example client device 600 may include one or more processors 602, data storage 604, one or more communication interfaces 606, and an I/O interface 608, all of which may be communicatively linked by a communication link 610 that may take the form a system bus and/or some other connection mechanism. Each of these components may take various forms.

For instance, the one or more processors 602 of the example client device 600 may comprise one or more processor components, such as one or more CPUs, GPUs, ASICs, DSPs, and/or programmable logic devices such as FPGAs, among other possible types of processing components.

In turn, the data storage 604 of the example client device 600 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 6, the data storage 604 may be capable of storing both (i) program instructions that are executable by the one or more processors 602 of the example client device 600 such that the example client device 600 is configured to perform any of the various functions disclosed herein (including but not limited to any of the client-device functions discussed above), and (ii) data that may be received, derived, or otherwise stored by the example client device 600.

The one or more communication interfaces 606 may comprise one or more interfaces that facilitate communication between the example client device 600 and other systems or devices, where each such interface may be wired and/or wireless and may communicate according to any of various communication protocols. As examples, the one or more communication interfaces 606 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 608 may generally take the form of (i) one or more input interfaces that are configured to receive and/or capture information at the example client device 600 and (ii) one or more output interfaces that are configured to output information from the example client device 600 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 608 may include or provide connectivity to output components such as a display screen and/or an audio speaker, among other possibilities.

It should be understood that the example client device 600 is one example of a client device that may be used with the example embodiments described herein. Numerous other arrangements are possible and contemplated herein. For instance, in other embodiments, the example client device 600 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

We claim:

1. A computing platform comprising:
at least one communication interface;
at least one processor;
at least one non-transitory computer-readable medium; and
program instructions stored on the at least one non-transitory computer-readable medium that, when executed by the at least one processor, cause the computing platform to:
load employee-related data for a given set of employees of an employer;
based on the loaded employee-related data, prepare input data for a set of artificial intelligence (AI) models that are each configured to (i) receive a set of input data related to an employee and (ii) based on an evaluation of the received input data, generate a prediction of whether the employee is likely to leave the employer within a model-specific timeframe in the future;
utilize the set of AI models to generate and output, for each respective employee in the given set, a respective set of predictions of whether the respective employee is likely to leave the employer within each of the model-specific timeframes in the future;
based on the respective sets of predictions that are generated and output by the set of AI models, predict that a future hiring need is likely to arise with respect to at least one given position within the employer; and
carry out one or more actions for enabling the employer to preemptively address the predicted future hiring need.

2. The computing platform of claim 1, further comprising program instructions stored on the at least one non-transitory computer-readable medium that, when executed by the at least one processor, cause the computing platform to:
utilize a model interpretability technique to generate, for each respective prediction of the respective sets of predictions, a respective set of feature contribution values for the respective prediction that indicate an extent to which different input features contributed to the respective prediction.

3. The computing platform of claim 1, further comprising program instructions stored on the at least one non-transitory computer-readable medium that, when executed by the at least one processor, cause the computing platform to:
generate, for each respective employee in at least a subset of the given set of employees, a respective retention strategy based on a respective set of input data related to the respective employee.

4. The computing platform of claim 1, further comprising program instructions stored on the at least one non-transitory computer-readable medium that, when executed by the at least one processor, cause the computing platform to:
select, from among the given set of employees, a group of employees who are similar to each other with respect to at least one of a department, a team, a job title, or a job function; and
generate a retention strategy for the group of employees based on respective sets of input data related to respective employees in the group.

5. The computing platform of claim 1, wherein the one or more actions include at least one of:
a remunerative action;
a training action;
a workload-calibration action;
a career-progression action; or
a feedback-based action.

6. The computing platform of claim 1, wherein the program instructions that cause the computing platform to carry out the one or more actions for enabling the employer to preemptively address the predicted future hiring need comprise program instructions that, when executed by the at least one processor, cause the computing platform to:
utilize a generative AI model to generate a job listing for the at least one given position based on the predicted future hiring need.

7. The computing platform of claim 1, wherein the program instructions that cause the computing platform to carry out the one or more actions for enabling the employer to preemptively address the predicted future hiring need comprise program instructions that, when executed by the at least one processor, cause the computing platform to:
cause an alert to be presented to a user based on the predicted future hiring need.

8. A non-transitory computer-readable medium, wherein the non-transitory computer-readable medium is provisioned with program instructions that, when executed by at least one processor, cause a computing platform to:
load employee-related data for a given set of employees of an employer;
based on the loaded employee-related data, prepare input data for a set of artificial intelligence (AI) models that are each configured to (i) receive a set of input data related to an employee and (ii) based on an evaluation of the received input data, generate a prediction of whether the employee is likely to leave the employer within a model-specific timeframe in the future;
utilize the set of AI models to generate and output, for each respective employee in the given set, a respective set of predictions of whether the respective employee is likely to leave the employer within each of the model-specific timeframes in the future;
based on the respective sets of predictions that are generated and output by the set of AI models, predict that a future hiring need is likely to arise with respect to at least one given position within the employer; and
carry out one or more actions for enabling the employer to preemptively address the predicted future hiring need.

9. The non-transitory computer-readable medium of claim 8, wherein the non-transitory computer-readable medium is further provisioned with program instructions that, when executed by at least one processor, cause the computing platform to:
utilize a model interpretability technique to generate, for each respective prediction of the respective sets of predictions, a respective set of feature contribution values for the respective prediction that indicate an extent to which different input features contributed to the respective prediction.

10. The non-transitory computer-readable medium of claim 8, wherein the non-transitory computer-readable medium is further provisioned with program instructions that, when executed by at least one processor, cause the computing platform to:
generate, for each respective employee in at least a subset of the given set of employees, a respective retention strategy based on a respective set of input data related to the respective employee.

11. The non-transitory computer-readable medium of claim 8, wherein the non-transitory computer-readable medium is further provisioned with program instructions that, when executed by at least one processor, cause the computing platform to:
select, from among the given set of employees, a group of employees who are similar to each other with respect to at least one of a department, a team, a job title, or a job function; and
generate a retention strategy for the group of employees based on respective sets of input data related to respective employees in the group.

12. The non-transitory computer-readable medium of claim 8, wherein the one or more actions include at least one of:
a remunerative action;
a training action;
a workload-calibration action;
a career-progression action; or
a feedback-based action.

13. The non-transitory computer-readable medium of claim 8, wherein the program instructions that cause the computing platform to carry out the one or more actions for enabling the employer to preemptively address the predicted future hiring need comprise program instructions that, when executed by the at least one processor, cause the computing platform to:
utilize a generative AI model to generate a job listing for the at least one given position based on the predicted future hiring need.

14. The non-transitory computer-readable medium of claim 8, wherein the program instructions that cause the computing platform to carry out the one or more actions for enabling the employer to preemptively address the predicted future hiring need comprise program instructions that, when executed by the at least one processor, cause the computing platform to:
cause an alert to be presented to a user based on the predicted future hiring need.

15. A method carried out by a computing platform, the method comprising:
loading employee-related data for a given set of employees of an employer;
based on the loaded employee-related data, preparing input data for a set of artificial intelligence (AI) models that are each configured to (i) receive a set of input data related to an employee and (ii) based on an evaluation of the received input data, generate a prediction of whether the employee is likely to leave the employer within a model-specific timeframe in the future;
utilizing the set of AI models to generate and output, for each respective employee in the given set, a respective set of predictions of whether the respective employee is likely to leave the employer within each of the model-specific timeframes in the future;
based on the respective sets of predictions that are generated and output by the set of AI models, predicting that a future hiring need is likely to arise with respect to at least one given position within the employer; and
carrying out one or more actions for enabling the employer to preemptively address the predicted future hiring need.

16. The method of claim 15, further comprising:
utilizing a model interpretability technique to generate, for each respective prediction of the respective sets of predictions, a respective set of feature contribution values for the respective prediction that indicate an extent to which different input features contributed to the respective prediction.

17. The method of claim 15, further comprising: generating, for each respective employee in at least a subset of the given set of employees, a respective retention strategy based on a respective set of input data related to the respective employee.

18. The method of claim 15, wherein the one or more actions include at least one of:
a remunerative action;
a training action;
a workload-calibration action;
a career-progression action; or a feedback-based action.

19. The method of claim 15, wherein carrying out the one or more actions for enabling the employer to preemptively address the predicted future hiring need comprises:
utilizing a generative AI model to generate a job listing for the at least one given position based on the predicted future hiring need.

20. The method of claim 15, wherein carrying out the one or more actions for enabling the employer to preemptively address the predicted future hiring need comprises:
causing an alert to be presented to a user based on the predicted future hiring need.
